(19) United States
(12) Patent Application Publication
(10) Pub. No.: US 2019/0373939 A1
(43) Pub. Date: Dec. 12, 2019

(54) Methods of Making a Bigger Volume of Foods for Weight Control

(71) Applicant: James Zhou Liu, Milford, DE (US)

(72) Inventor: James Zhou Liu, Milford, DE (US)

(21) Appl. No.: 16/003,080

(22) Filed: Jun. 7, 2018

(51) Int. Cl. A23L 33/00; G01F 23/02

(52) U.S. Cl. CPC A23L 33/40; A23V 2002/00; G01F 23/02; A23L 33/30

(57) ABSTRACT

The present invention is related to the composition and process of making the desired foods with big volume for weight control. Water, hydrocolloids and premix of nutrients are the major ingredients to make the new food with bigger volume than its original formulation. The new food is high in nutrients and low in calorie density for weight loss. The new food can also be high in nutrients and high in calorie for weight gain after adjusting the composition. A new instrument named Meal Cylinder is provided for measuring the quality and quantity of the food, and for food labeling and for nutrition education. Meal Cylinder links everyone's innate ability of the stomach fullness to the quality and quantity of the food. Hence, it has a practical usefulness for weight control. Using Meal Cylinder, one can select the appropriate foods and meals for special purposes. Foods and meals are categorized according to its Meal Cylinder fullness level, as well as its calorie and nutrient cylinder fullness levels. One standard meal named 1Meal was defined. A variety of foods with varying Meal Cylinder fullness level, calorie cylinder fullness level, and nutrient cylinder fullness level can be manufactured to meet the different purposes for increasing, decreasing or maintaining an individual's body weight. The compositions and method of new gelatinization to increase the volume of the existing food to gain significant effect of satiation and satiety for weight control were also provided. The user can easily and joyfully consume these desired foods with high nutrients but low calorie to manage body weight without hunger. The new gelatinized foods have the characters that almost all water can be in the non-free-flow status, such as gelatinized soups or gelatinized nutritional beverages. The gelatinized foods offer longer effect of fullness compared to the previous liquid foods. Obesity can be eradicated when these desired foods with a bigger volume and Meal Cylinder are commonly used. The current invention is to benefit the great human society for a long time. The same Meal Cylinder method and the new type of the desired gelatinized foods can also be used to manage body weight of certain domestic animals.

### BACKGROUND OF THE INVENTION

### 1. Field of the Invention

The present invention relates to a new composition and method of manufacturing the foods high in volume, high in nutrients but low in calorie, and a new instrument named Meal Cylinder to measure food quality and quantity, to enable the general public to use foods correctly and easily to manage their body weight. The new way of weight control, becomes much easier by using the newly invented foods and the newly created instrument for labeling the food. Any individual can reduce, increase or maintain the body weight by selectively consuming the right types of foods with the appropriate amount for reaching a happy fullness. Reducing weight can be achieved by consuming a full meal with a big-enough volume with less calorie. Now consumers have an easy way to decide to have either a positive, negative or balanced calorie intake to change his body weight without hunger, and with adequate intake of nutrition for his long-term health.

### 2. Description of the Related Art

The human's digestive tube, or gastrointestinal tract, can be described as a soft cylinder with a varied length, diameter and shape. When this cylinder is fully filled with food after a meal, we feel full. When this cylinder is totally emptied, we feel hungry. Reaching a fullness, like satisfying a sex drive, is an innate ability for survival, and for human being's continuation generation by generation. Many dieting approaches to lose weight are against this innate need and hence failed. Many dieting drugs to disturb this human basic need in physiology failed again and again. It is the time to have the real solution.

It is well-known that overweight or obesity is caused by extra calorie intake, while underweight is caused by lack of calorie intake, which is traditionally called malnutrition. The source of calorie is food. Protein, fat and carbohydrate are the three calorie sources in foods. The calorie concentration in the food can be increased or decreased by water and fiber content, which has a significant effect for decreasing or increasing body weight. Water is a major component of foods and can be easily obtained from nature. Water is abundant in all living things and consequently, in all fresh natural foods. Most natural foods contain water about 70% of their weight or greater unless they are dehydrated. Fresh fruits and vegetables contain water up to 90% or greater, which are high in nutrients but low in calorie. These types of foods are to be manufactured mainly in this invention. Using foods to increase body weight was well taught in the prior arts so this invention will have less effort on that.

Many food scientists divide water into three forms: free, adsorbed, and bound. Free water is the water that can literally be squeezed out of a food, like the juice in an orange, or the water that sometimes separates in sour cream or yogurt. Soft drinks, liquid nutritionals, and soups contain a large percentage of free water, and their effect for fullness is short-lived. Adsorbed water is water that is attached to the surface of molecules like polysaccharides and proteins. It is not readily squeezed out of the food. When food scientists refer to the hydration of proteins, such as gluten, and carbohydrates, such as starch, they are referring to adsorbed water. Adsorbed water moves through the gastrointestinal tract much slower than free water, hence it fullness effect is longer. Currently, however, adsorbed water has not been paid enough attention for weight loss. Bound water is water that is physically trapped within crystals, such as crystalline starch, or other substances in food (some food scientists prefer to define just the free and bound forms of water).

Adsorbed water plays many very important roles in food. It affects texture and volume (dry and brittle versus moist, and soft), enables the activity of enzymes and chemical reactions to occur (acts as a solvent), supports the growth of microorganisms, makes it possible for large molecules like polysaccharides and proteins to move about and interact, and conducts heat within food. Many foods such as meat, poultry, seafood, fruits and vegetables are composed of 75% and more water, so water is the most abundant component in many fresh foods. Liquid nutrition, such as Ensure® Plus contains 70% water (176 g water in one serving of 252 g). Other foods such as dairy products, and fresh baked goods also contain high levels of water (about 35% or more).

It has been suggested that caloric soft drinks could lead to excess energy consumption because energy from liquids fails to trigger satiety compared with equivalent energy intakes from solid food (Mattes 2006). Energy density is the amount of energy in a given weight of food or drink (kJ/g, kcal/g). A number of studies have shown that, when subjects are allowed free access to a range of foods, they will consistently consume a similar weight of food each day, rather than a constant amount of energy (Rolls 2000). This means that the lower the energy content of the foods eaten (i.e. the less energy dense they are), the lower overall energy intake will be and vice versa.

For weight control, everyone needs to know satiation and satiety, which are part of the body's appetite control system and are involved in limiting energy intake. Satiation is the process that causes one to stop eating; satiety is the feeling of fullness that persists after eating, suppressing further consumption, and both are important in determining total energy intake. Free water has the relatively a strong effect of satiation, but much weak effect of satiety.

Satiation and satiety are controlled by a cascade of factors that begin when a food or drink is consumed and continues as it enters the gastrointestinal tract and is digested and absorbed. Signals about the ingestion of energy feed into specific areas of the brain that are involved in the regulation of energy intake, in response to the sensory and cognitive perceptions of the food or drink consumed, and distension of the stomach. These signals are integrated by the brain, and satiation is stimulated. When nutrients reach the intestine and are absorbed, a number of hormonal signals that are again integrated in the brain to induce satiety are released. In addition to these episodic signals, satiety is also affected by fluctuations in hormones, such as leptin and insulin, which indicate the level of fat storage in the body.

Satiation and satiety can be measured directly via food intake or indirectly via ratings of subjective sensations of appetite. The most common study design when measuring satiation or satiety over a short period is using a test preload in which the variables of interest are carefully controlled. This is followed by subjects rating aspects of their appetite sensations, such as fullness or hunger, at intervals and then, after a predetermined time interval, a test meal at which energy intake is measured. Longer-term studies may provide foods or drinks of known composition to be consumed ad libitum and use measures of energy intake and/or appetite ratings as indicators of satiety. The measurement of satiation and satiety is complicated by the fact that many factors besides these internal signals may influence appetite and energy intake, for example, physical factors such as bodyweight, age or gender, or behavioral factors such as diet or the influence of other people present. For this reason, the majority of studies on satiation and satiety take place in a laboratory, where confounders can be controlled as much as possible, and are, therefore, of short duration.

It is possible for any food or drink to affect appetite, and so it is important to determine whether, for a given amount of energy, particular variables have the potential to enhance or reduce satiation or satiety. A great deal of research has been conducted to investigate the effect of different foods, drinks, food components and nutrients on satiety. Overall, the characteristic of a food or drink that appears to have the most impact on satiety is its energy density. That is the amount of energy it contains per unit weight kJ/g, kcal/g). When energy density is controlled, the macronutrient composition of foods does not appear to have a major impact on satiety. In practice, high-fat foods tend to have a higher energy density than high-protein or high-carbohydrate foods, and foods with the highest water content tend to have the lowest energy density, Some studies have shown that energy from protein is more satiating than energy from carbohydrate or fat. In addition, certain types of fiber have been shown to enhance satiation and satiety. It has been suggested that energy from liquids is less satiating then energy from solids. However, evidence for this is inconsistent, and it may be the mode of consumption (i.e. whether the liquid is perceived to be a food or drink) that influences its effect on satiety. Alcohol appears to stimulate energy intake in the short-term, and consuming energy from alcohol does not appear to lead to a subsequent compensatory reduction in energy intake.

The consumption of food and drink to provide energy is a voluntary behavior, and, despite the existence of sophisticated physiological mechanisms to match intake to requirements, humans often eat when sated and sometimes refrain from eating when hungry. Thus, there are numerous influences on eating behavior beyond satiation and satiety. These include: the portion size, appeal, palatability and variety of foods and drinks available; the physiological impact on the body of physical activity and sleep; and other external influences such as television viewing and the effect of social situations.

Because satiation and satiety are key to controlling energy intake, inter-individual differences in the strength of these signals and responsiveness to their effects could affect risk of obesity. Such differences have been observed at a genetic, physiological and behavioral level and may be important to consider in strategies to prevent or treat obesity.

Overall, it is clear that, although the processes of satiation and satiety have the potential to control energy intake, many individuals override the signals generated. Hence, in such people, satiation and satiety alone are not sufficient to prevent weight gain in the current obesogenic environment. Knowledge about foods, ingredients and dietary patterns that can enhance satiation and satiety is potentially useful for controlling bodyweight. However, this must be coupled with an understanding of the myriad of other factors that influence eating behavior, in order to help people to control their energy intake.

For the fullness effect, the free-flow water can only stay in the gastrointestinal tract for about 20 minutes. Adsorbed water can stay in the gastrointestinal tract for a much longer time, such as 2 to 4 hours depending upon which foods carry the adsorbed water. Therefore, in the disclosed instrument for measuring the fullness effect, free-flow water and adsorbed water will be assigned two very different coefficients.

SlimFast Advanced Shakes has been widely for weight loss although the research did not directly link it to weight loss. It seems that there are no dedicated peer-reviewed studies and elements in the formula that could slow the digestive process, like fiber, to reduce hunger and slow the onset of appetite are missing. One user responded: “The vanilla flavor is really good. However, not really satisfying as to curbing hunger pangs. Lasts only a short period of time.” This is possibly due to the fact that SlimFast Advanced Shakes contains a big portion of free-flow water, hence it has a short time effect of fullness. It is generally true that nutritional beverages are not as effective as solid foods in terms of satiety. It will be more effective as a weight loss product when the fullness effect of SlimFast is improved.

The normal happy life needs to eat, drink, and be merry. Our body gets used to a level of energy through satisfying hunger. When we diet, we usually eat too little food. While the weight was reduced, the hunger feeling often surfaces. Hunger pangs try to force energy intake back to the non-diet level. There are many ways to stop those pesky hunger, pangs. The disclosed methods and products here will address this issue.

Protein has a strong satiety effect, and acts as an appetite suppressant to help control hunger pangs. However, too much protein intake is not healthy. It was reported that eating about 50 grams of protein triggered a 25 percent spike in energy, increasing fat metabolism 32 percent, and lasting up to four hours, in research conducted by the University of Wollongong in Australia. A protein alternative for satiety should be used.

Dietary fiber has a strong satiety effect, and acts as another appetite suppressant to help control hunger pangs. Most Americans consume only about half the amount of fiber recommended by the Institute of Medicine. Recognizing that Americans are not consuming enough food-based sources of fiber, the Dietary Guidelines Advisory Committee believed it was critical to make changes to the Dietary Guidelines for Americans in order to better inform and educate Americans about their food choices for fibers. This emphasis on whole grains and other inherent sources of fiber has impacted product development and reformulation by food manufacturers, and in turn has impacted the fiber food ingredient business. With low fiber intakes, consumers need a variety of options to help them bridge the fiber gap and feel full. Adding fiber food ingredients to no- and low-fiber foods that people already like and eat is a practical solution to meet fiber recommendations without adding significant calories to the diet. There are now more than 50 different types of fiber food ingredients available to reformulate food items.

Adsorbed water acts as another appetite suppressant to help control hunger pangs. However, foods that are high in moisture are at risk of contamination from the growth of microorganisms such as bacteria, yeast, and mold, while dry foods like pasta generally have long shelf lives. The modern food manufacturing practice can largely eliminate the risk of microbial contamination of the food. It is important to have adsorbed water in food to have a longer effect of fullness than free water.

Diet drink helps weight loss for a short period of time. People purchase diet drinks because of their low caloric values. According to Dartmouth University, the artificial sweeteners used in these drinks contain 600 times more sweetness than natural sugar. This allows manufacturers to use the sweetener in smaller portions, so the drink will taste just as sweet as the original, without the additional calories. Harvard University reports that switching from regular soft drinks to diet drinks can cause an immediate decrease in the number of calories that one put in the body each day. Despite the fact that many diet drinks do not contain any calories, some studies suggest that they can actually lead to weight gain. Harvard University suggests that human beings have an innate ability to tell how many calories they put into their bodies based on how something tastes. Since diet drinks taste like they contain calories, but in fact do not, it throws the body's ability off, which leads to people consuming more calories in their daily lives through other foods. In addition, some studies have shown that those who consume diet drinks throughout their lives show signs of metabolic syndrome. According to the University of Rochester Medical Center, some of these individuals experienced symptoms such as high blood pressure, high blood sugar, lower than normal levels of HDL cholesterol and larger waste sizes. While you cannot draw a conclusion from this information without further research, the presence of these symptoms suggests a danger to diet drinks. Soft drink is less effective than dietary fibers for weight loss.

Dietary fibers are a heterogeneous group of food compounds. Generally, dietary fibers are indigestible carbohydrates (i.e., cellulose, hemicelluose, β-glucans, pectins, gums fructans and resistant starch) and lignins intact and intrinsic in fruits, vegetables, legumes and cereals. Chemically, dietary fibers include non-starch polysaccharides such as cellulose, hemicellulose, β-glucans, polyfructoses (i.e., inulin), natural gums and heteropolymers (i.e., pectin) as well as natural or synthetically produced oligosaccharides, i.e., fructo-oligosaccharides, or galacto-oligosaccharides. These compounds vastly differ in their structural, physical and chemical properties, namely water solubility, viscosity, binding and bulking ability and fermentability.

Water soluble and viscous fibers include polysaccharides such as plant-derived pectin, β-glucans, psyllium/ispaghula husks, natural gums, galactomannans and alginates. Once dissolved in water, viscous fibers form gels and/or thicken, a physicochemical characteristic that may impact intestinal motility and absorption rates of glucose, triglycerides and cholesterol. Randomized, controlled studies reported that viscous and/or gel-forming fibers may improve glycemic and insulinemic responses. In fact, the European Food Safety Agency (EFSA) authorized the health claim that consumption of 4 g of β-glucans (derived from barley and oats) per 30 g of available carbohydrates is sufficient to reduce postprandial glucose concentration in the range of clinical significance.

The viscous fiber psyllium has been reported to lower postprandial glucose concentrations and improve insulin sensitivity in healthy, obese and T2DM individuals. This positive effect on postprandial glycemia was reported in intervention studies ranging from 6 weeks to 6 months with doses of 10-14 g psyllium per day. A meta-analysis of 4 studies (duration 2 to 24 weeks) in T2DM individuals showed that psyllium intake decreased fasting glucose concentration by 37 mg/dL and reduced. HbA1c (−10.6 mmol/mol) compared to placebo. Similar, 6-week supplementation of 10 g/d natural partly hydrolyzed guar gum reduced fasting glucose and insulin concentration in healthy men, and HbA1c concentration in T2DM patients. However, other studies with hydrolyzed guar gum supplementation in T2DM patients reported no effect on glycemia. Acute reduction of subjective appetite rating and acute energy intake was reported after intake of pectin (mean dose 14.2 g/day and 4.8 g/day, respectively) and β-glucans (mean dose 6.2 g/day and 5.8 g/day, respectively) compared to the control food.

Dietary fiber has a healthy role in reducing obesity. Obesity has a far-ranging negative effect on health. Each year obesity-related conditions cost over 150 billion dollars and cause an estimated 300,000 premature deaths in the US alone. The health effects associated with obesity include, but are not limited to, high blood pressure, diabetes, heart disease, joint problems, sleep apnea and respiratory problems, cancer, metabolic syndrome, and psychosocial effects. Obesity becomes pandemic not only in the developed world also in the developing countries. Its harmful effects in health and economy for the human society are too severe to bear for any longer. This invention is to provide the method fundamentally to resolve this crisis.

It is not much hope to look to dietary supplements for help in burning calories for weight loss. Products that claim to speed up individual's metabolism are often more hype than help, and some may cause undesirable or even dangerous side effects.

Before today, there was no easy way to lose weight other than surgery. The foundation for weight loss continued to be based on correcting “eat too much but exercise too little.” Experts can very accurately advise you that you take in fewer calories than you burn, and you lose weight. However, in practice, the general public do not know how to measure and reduce these few calories.

The 2015 Dietary Guidelines for Americans recommends cutting calories by 500 to 700 calories a day to lose 1 to 1.5 pounds (0.5 to 0.7 kilograms) a week. If you can add some physical activity to your day, you'll accomplish your weight-loss goals eventually. The challenge again, however, in practice, the general public do not know how to measure and reduce these few calories.

Knowledge about the mechanisms that impact appetite, food selection, and how your body processes and burns food is increasing. Your doctor, registered dietician or other experts can help you explore interventions that can help you lose weight. At what cost? Is it easy? Can you learn and practice easily by yourself? It is needed to have an easy to use system for you to follow and to use in daily practice.

Numerous weight loss products are currently available in the market for consumers to choose. Many products contain one or a few active ingredient(s) to have some effects. The right, weight loss product should be easy to use and safe, and to cause weight loss gradually for a long period of time. It should not cause the user to suffer or struggle with hunger, not cause malnutrition, not reduce the work-needed energy level, and not negatively impact the user's well-being. In addition, an effective product for weight loss must be easy to use, and the method is sustainable with or without the user's strong willpower. It should be to deliver the result without a big change in the normal life. This objective has challenged nutritional scientists and medical doctors worldwide for the last 50 years. Now it is the time to create an ideal system to help millions to achieve the goal of significant and sustained natural weight control.

Earlier in 1984, the named inventor designed a method termed as “a Calorie-Nutrients Quadrant (CNQ) to classify foods into four categories: Category I—high calorie and high nutrients; Category II—low calorie and high nutrients; Category III—low calorie and low nutrients; Category IV—high calorie and low nutrients. (Liu and Lin 1984). Overweight and obesity has been linked to the imbalance of food intakes, particularly caused by consuming more foods with high calorie and low nutrients in Quadrant IV. For dietary management of overweight and obesity, one should consume more foods in Quadrant II—low calorie and high nutrients. Theoretically, the goal of losing weight by consuming the right foods is reachable. However, in practice, it is very hard to do. The number one reason is that many non-nutritional general public have a hard time to select the right foods. Number two reason is that the naturally produced foods have their limitation. It is hard for any single foods to have a complete nutrients profile to meet the human body's need. Professional nutritional education and dietary coaching can only help a small percentage of these overweight and obese people.

Recently, experts paid attention to fullness (Australian study 1995) and created the “Fullness Factor” (Online) to help people to lose weight. Due to the limitations of these new methods, the society is far from being provided with an easy to use and effective system in weight control.

The US government agencies have been trying very hard to help the consumers and industries to fight against obesity. Food labels have been created and updated periodically but these numbers in calories, grams, milligrams, micrograms and international units of this and that nutrient seems the out-space languages and are hard for being comprehended by the general consumers, Food labels are easy to be used by food lab technicians. It is the fact that majority of the consumers are not professionals working in the food or nutritional laboratories. The best-known Dietary Reference Intakes (DRI) issued by the Food and Nutrition Board of the Institute of Medicine, National Academy of Sciences were based on the daily dietary intake. How many consumers can add up their calorie and nutrient intakes from each of the three or more meals to the daily total? How should they eat during each meal to have the right daily total? Even for these nutritionists, who can use the food label or DRI for eating right during each meal? This invention is to bring all parties' attention to each meal.

Each meal is the primary unit for every day's dietary intake and must be fully aware by the consumer. The “my-plate” approach from the USDA by dividing foods into 4 groups is still far from being able to measure calorie and nutrient intakes by the consumers.

At this time, an academy, industry and governmental joint-approach must be taken and introduced to help the population to manage the body weight. The medical, nutritional and food science professionals should design, create, develop, test, and manufacture the right foods for preventing and treating obesity and for being used to manage the body weight during each meal. The two well-known nutritional products with the brand names of Ensure® and SlimFast® paved the way for developing more cost-effective products for weight control. These nutritional products have a significant or noticeable percentage of fat and sugar. Fat or sugar should come from the regular foods. The current invention is to create a new system for people to easily master and use the very practical system for weight control.

### SUMMARY OF THE PRESENTLY CLAIMED INVENTION

### Brief Description of the Drawings

FIG. 1 shows a comparison between the meal cylinder fullness level of calorie and calorie count. The meal cylinder fullness level uses the percentage to describe how much fullness is reached when a special food is consumed. Calorie count uses the actual calorie number to describe how many calories are taken when a special food is consumed. It is easier for the general consumers to use calorie percentage, not actual calorie count.

FIG. 2 shows that five foods and their Calorie Counts (A) or Cylinder Fullness Level (B).

FIG. 3 shows a Calorie Cylinder Fullness Cartesian Coordinates. The ideal food or meal has the Gastrointestinal Cylinder Fullness Level at 100 and Calorie Cylinder Fullness level at 100.

FIG. 4 shows a Calorie Cylinder Fullness Cartesian Coordinates. Four different foods played different roles in satisfying the need for fullness and for calorie. The general consumers can use this tool to select the right food for meeting his/her right need in losing, maintaining or gaining body weight

FIG. 5 was a photo of a physical Two-Dimensional Fullness-Ruler for measuring the Gastrointestinal Cylinder Fullness Level and Calorie Cylinder Fullness level.

FIG. 6 shows a standard solid food named 1Meal to meet the consumer's need for a 100% fullness with 500 grams in weight containing 1000 calories and 50% nutrients specified in the DRI for an adult man.

FIG. 7 shows a standard liquid food named 1Meal to meet the consumer's need for a 100% fullness with 500 ml in volume containing 1000 calories and 50% nutrients listed in the DRI for an adult man.

FIG. 8 shows the plots of the Calculated Meal Cylinder Fullness Level v Food Calorie Density to compare the published Satiety Index v Food Calorie Density. The newly invented tool shows a better relationship between Meal Cylinder Fullness Level v Food Calorie Density.

FIG. 9 shows a correlation relationship between Meal Cylinder Fullness Level and Satiety Index.

FIG. 10 shows a correlation relationship between Meal Cylinder Fullness Level and the meal serving size.

FIG. 11 shows a correlation relationship between Satiety Index and the meal serving size.

FIG. 12 shows a pyramid of composition of a food product for weight management.

### DETAIL DESCRIPTION

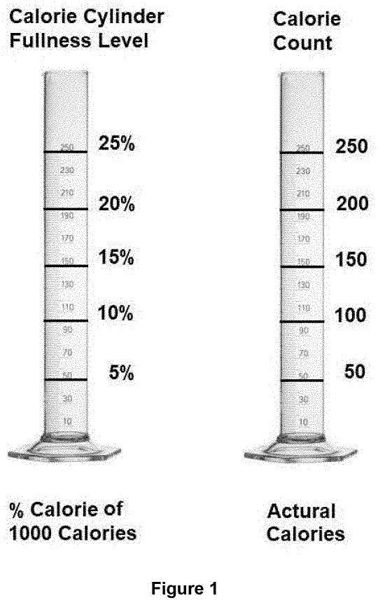

In the current invention, a man's digestive tube, or gastrointestinal tract, is described as a soft cylinder with a varied length, diameter and shape, and this biological cylinder can be simplified as a laboratory cylinder like container to ease food labeling and nutrition education, as shown in FIG. 1. When his gastrointestinal cylinder is filled with 25% volume after a meal, his gastrointestinal cylinder fullness level is 25%. When his gastrointestinal cylinder is accurately fully filled after a meal, his gastrointestinal cylinder fullness level is 100%. When his gastrointestinal cylinder is totally emptied, he will feel hungry, and then his gastrointestinal cylinder fullness level at that time is 0.

To understand our invention, we provide a simple mathematic calculation. For weight gain or weight loss, in terms of calorie intake and usage, it is a simple calorie balance. If 1−1=0, then calorie intake from foods and calorie expenditure by the body is the same. If 1−0.9=0.1; then calorie intake is greater than calorie usage. Hence, weight gain occurred. If 1.0−1.1=−0.1, then calorie intake is less than calorie usage. Thus, weight loss occurred. Calorie expenditure varies greatly, and in many cases, is not as easy to control as in managing calorie intake for impacting weight gain or weight loss. This disclosure, therefore, is to focus on calorie intake.

The current invention also discloses a gastrointestinal calorie fullness cylinder. When a person's gastrointestinal calorie cylinder is filled with 15% calorie (150 kilo calories) after a meal, his calorie cylinder fullness level is 15%, as shown in FIG. 1. When the calorie cylinder is filled with 1000 calories after a meal, his calorie cylinder is full, and his calorie fullness level is 100. When this calorie cylinder is totally emptied, the person may need to have the next meal, and then his calorie fullness level at that time is 0.

The current invention also discloses a gastrointestinal nutrient fullness cylinder. The illustrative figure is similar to the calorie cylinder so it is omitted here. When a person's gastrointestinal nutrient cylinder is fully filled with food containing 50% of his daily requirement for this nutrient after a meal, his nutrient cylinder is full, and his nutrient cylinder fullness level is 100. When his nutrient cylinder is totally emptied, he may need to have the next meal to meet his need for this nutrient, and then his nutrient fullness level is 0. Here, 100% fullness of the nutrient cylinder is met with one meal, not met by a whole day food intake. The optimal diet for the whole day is to have 100% nutrient fullness in two major meals, or have 100% nutrients per the daily reference value.

Here, one meal is the unit to measure nutrient intake, not by a daily total for a good practical reason. Any one knows if he or she is full after one meal but it is hard for him/her to sum up the daily total intake by adding the different nutrient intakes from several meals in a day.

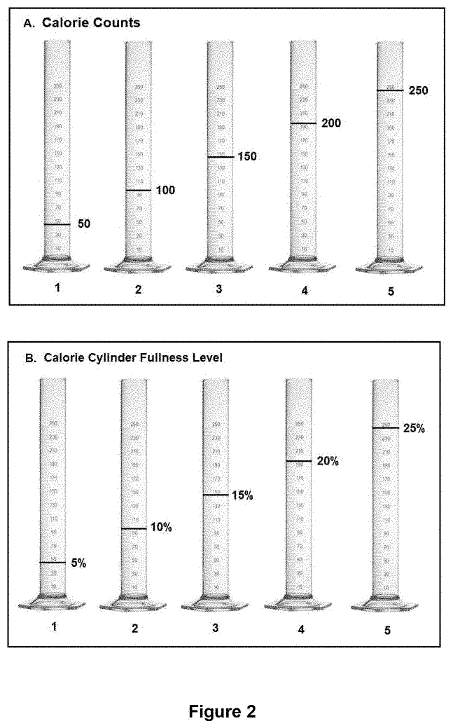

The current invention discloses a fullness cylinder for a man to measure and record his fullness, to evaluate the food quality and quantity to guide him for selecting the right food for his wellbeing, and for body weight management. This Fullness cylinder can be a straight one-dimension gradient respectively labeled with gastrointestinal tract cylinder fullness level, or calorie cylinder fullness level; or nutrient cylinder fullness level. Each cylinder can start with 0 and the maximum number can be 100 or 500, since some big meals may have a huge amount of calorie or nutrient, several times more than needed from one meal. As an example, the five different foods have different calorie accounts and calorie cylinder fullness levels. It is much easier for the consumers to use the calorie cylinder fullness levels. See FIG. 2.

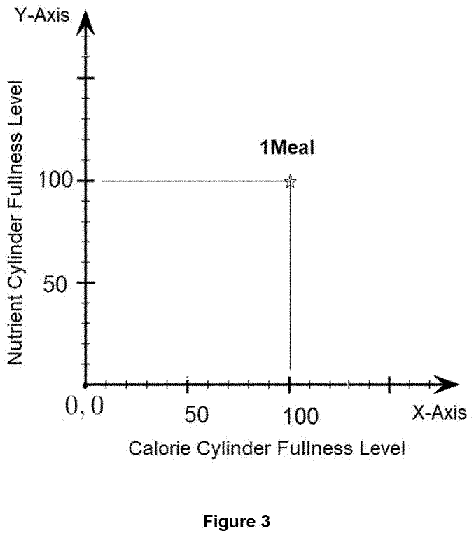

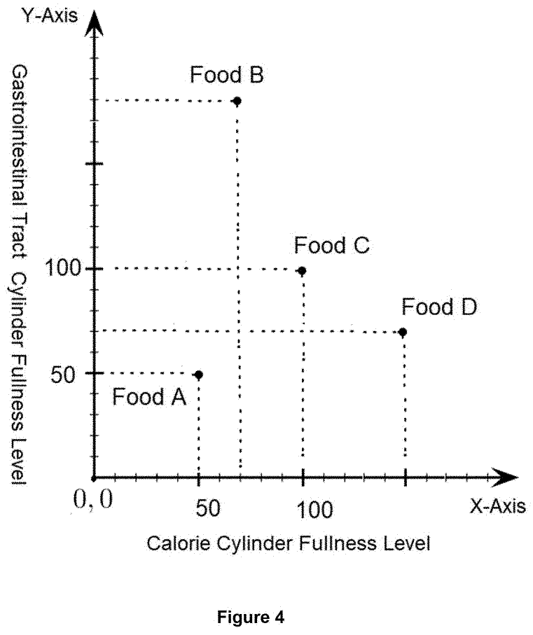

The current invention also discloses a two-dimensional fullness cylinder for a man to measure and record his gastrointestinal cylinder fullness level, or nutrient cylinder fullness level, against calorie cylinder fullness level. See FIG. 3. If the gastrointestinal cylinder fullness level and the calorie cylinder fullness level are both 100, then it is a balanced meal. See FIG. 3. Some other foods or meals have the imbalanced plot between the gastrointestinal cylinder fullness level and the calorie cylinder fullness level, See FIG. 4, This 2-dimensional fullness ruler can be used by nutritional educators to inform the public on how to plan each meal to get the balanced calorie intake if the primary goal is to maintain the body weight. It can also lead to the general consumers to select the meal with a higher gastrointestinal cylinder fullness level and lower calorie cylinder fullness level to lose body weight. It can also lead to the general consumers to select the meal with a lower gastrointestinal cylinder fullness level and higher calorie cylinder fullness level to gain body weight.

The 3-dimensional fullness cylinder composes (1) the gastrointestinal fullness cylinder, (2) the calorie fullness cylinder, and (3) the nutrient fullness cylinder. This 3-dimension fullness-cylinder system can be used by nutritional educators to inform the public on how to plan each meal to have the fullness, to get the balanced calorie intake and enough nutrients. This can lead to the general consumers to select the right meal for the right purpose in terms of weight management.

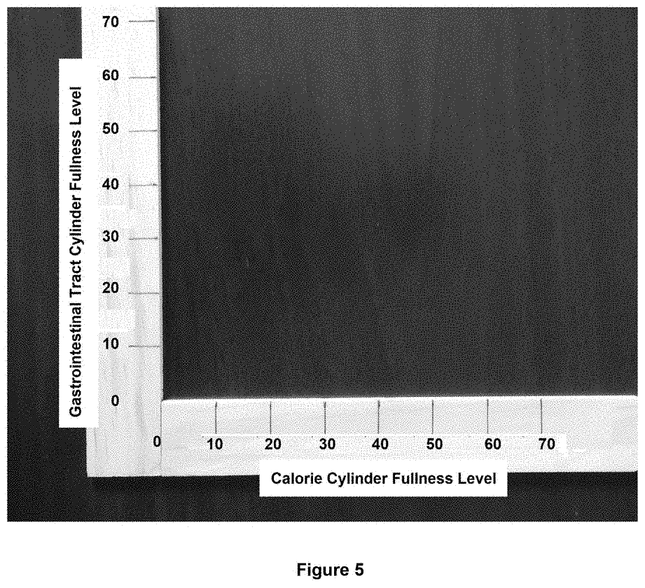

The fullness cylinder can be made by using plastic, metal, wooden or the other safe materials, or in electronic form, or in mathematical formulas. See FIG. 5. Each dimension starts with 0, and the maximum number can be 100 or 500, since some big meals may have a huge amount of calorie or nutrient or can cause a far over fullness.

Satisfying fullness is an innate need for survival and for daily happiness. Any approach of eating less to suffer certain degree of hungry to lose weight is against this innate need and hence failed. Many dieting drugs to disturb this human basic physiological need failed again and again. The newly invented method is to let the individual eat to the fullness to lose, to maintain or to gain body weight. They key is what kinds of foods in each meal should be consumed.

Almost all consumers know if she/he is full after a meal without reading any food label for the amount of nutrients or calories. However, almost no one knows how many calories were consumed after one meal if the calorie number was not pre-labeled, such as eating in some restaurants. The current disclosure is to teach the public a new method of knowing the food quality and quantity which is to be measured directly by individual's gastrointestinal fullness, or simply, one's fullness. This meal-cylinder system should be used for food label, as the current food label system could not help the consumers to link her/his fullness directly with calorie or nutrients.

The current invention is a significant improvement of the previously designed method called Calorie-Nutrients Quadrant (CNQ) in 1984 by the named first inventor. The CNQ method classified foods into four categories: Category I—high calorie and high nutrients; Category II—low calorie and high nutrients; Category III—low calorie and low nutrients; Category IV—high calorie and low nutrients. (Liu and Lin 1984). Dividing all foods into these 4 categories help the general public to select foods for meeting her/his special need. However, the CNQ method was more on the theory side, far from the daily actual use in food selection since no food industry to label their foods into any of the 4 categories. This time, the inventors are creating the new method called the Gastrointestinal Cylinder Fullness Level. Each person's gastrointestinal tract can be described as a long but irregular cylinder. The gastrointestinal cylinder can be fulfilled with a meal, or food. This cylinder fullness of the gastrointestinal tract can be sensed or measured by an individual, such as “I am half full, or I am fully full” after a meal. How much total foods were consumed during one meal can be measured in many ways, such as a parallel approach—one two cylinders contain the identical amount of the mixed foods. The person can consume the food in one cylinder. When the 50% or 100% fullness is reached, how much volume or weight of the food was consumed can be measured by comparing with the other cylinder. Therefore, the gastrointestinal cylinder fullness level can be used as a measurement to qualify and quantify foods and meals.

For weight loss, Volumetrics has been well known. It was created by Barbara Rolls, Ph.D., the endowed Guthrie Chair in Nutrition at Pennsylvania State University. Dr. Rolls has been president of the Society for the Study of Ingestive Behavior and the North American Association for the Study of Obesity. In her laboratory at Penn State, Dr. Rolls has studied dietary patterns and eating behavior. Based on her team's research, she has determined that the volume of food that people eat affects both how satisfied they feel and how much they eat. Dr. Rolls' team scientists observed that over the course of a day or two, a person eats about the same weight of food. To lose weight, then, a person can lower the calories in each portion of food while maintaining the same amount of food. If a dieter eats the Volumetrics way and increases the water and fiber content in their daily food intake, he or she will still feel full. However, because the person is taking in fewer calories than before, weight loss will occur. However, general consumers are lack of nutritional knowledge and have a hard time to select the right foods under Volumetrics. This invention provides the method to manufacture the new foods with a bigger volume but lower calorie than its original.

According to Volumetrics, the fullness of the gastrointestinal tract can be sensitively sensed by the volume of a food and meal, not much by calorie intake. The cylinder fullness of the gastrointestinal tract, therefore, can be a practically tool for measuring the satiation and satiety effect of foods or a meal. The current invention is to define and how to use this new tool. Water soluble dietary fibers can increase the volume of foods, which leads to an increased satiety effect. Many new foods are doubled its original volume by using the currently disclosed methods.

The gastrointestinal cylinder can be fulfilled with solid, semi-solid or liquid food. Thus, all kinds of foods should be measurable by using the new method of Meal Cylinder. Gladly, the gastrointestinal cylinder fullness level can be used to measure all kinds of foods and meal. Since after the solid, semi-solid or liquid food enter into the gastrointestinal tract, all become the fulfilling material and moveable inside that cylinder (tube). And, all kinds of foods produce certain level of the fullness effect.

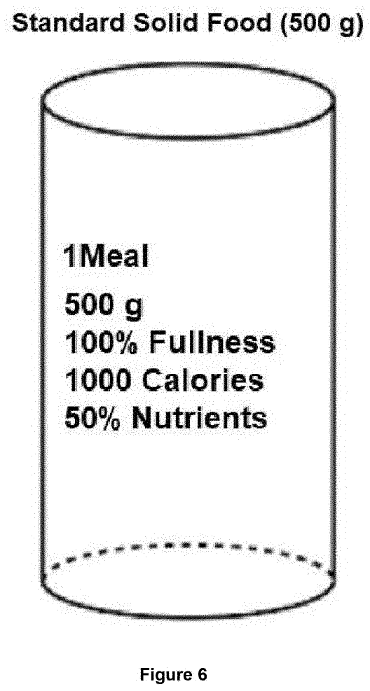

It is commonly known that the solid, semi-solid and liquid food and meal has different effect of immediate fullness, but the length of fullness varied greatly. Some meal has the short, some pothers have the long-time fullness effect. Therefore, it is needed to have an objective method to measure the long-term fullness level as the short fullness is less important. For meeting this purpose, it is needed to have a standard food or standard meal, called 1Meal, as shown in FIG. 6.

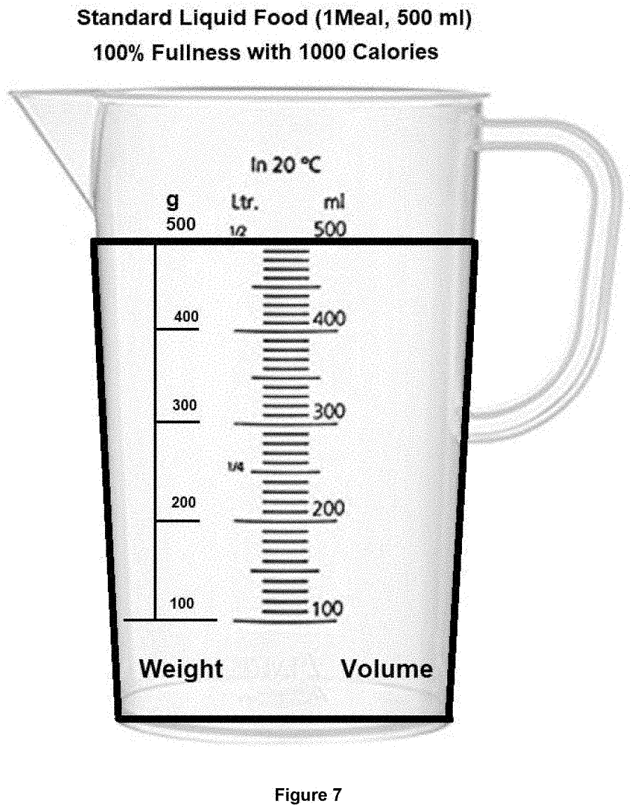

The standard liquid food (1Meal-L) is defined as the food is in 500 ml in volume, contains 250 g (50%) adsorbed water, 1000 calories, total fat 33.3 g (300 calories), protein 80 g (240 calories), total carbohydrate 95 g (460 calories), dietary fiber 40 g, as shown in FIG. 7.

The standard solid food (1Meal-S) is defined as the food is weighing 500 g (1.1 pounds), contains 250 g (50%) adsorbed water, 1000 calories, total fat 33.3 g (300 calories), protein 80 g (240 calories), total carbohydrate 95 g (460 calories), dietary fiber 40 g.

Based on the published research, total volume, dietary protein and fiber of the meal are significant contributors to the gastrointestinal fullness. Fat and carbohydrates are less significant. Their contribution to the meal cylinder fullness is represented by total calorie. Food weight almost directly reflects the food volume as the density is generally is 1 g in 1 ml, or 1 kg in 1 liter. Food weight/volume counted for the big part of the gastrointestinal cylinder fullness, so does adsorbed water. Based on these scientific evidence, the below formula is created to calculate the Meal Cylinder fullness level for solid foods:

Meal Cylinder Fullness Level of a Food (Meal)=0.02*Serving Size Weight (g)+0.01*Total Calorie+0.5*Protein (g)+0.5*Fiber (g)+0.02*Water (g). If for free-flow water, its coefficient will be reduced by half, or 0.02 becomes 0.01 for calculating.

For the standard meal of the solid food (1Meal-S), its Meal Cylinder Fullness Level=0.05*500+0.01*1000+0.5*80+0.5*40+0.02*250=25+10+40+20+5=100. Therefore, the weight accounts for 25%; total calorie, 10%; protein 40%; fiber 20% adsorbed water 5%.

For calculating the gastrointestinal cylinder fullness level of 1 head of a medium head cauliflower: The Cylinder Fullness Level=0.05*588 g (weight)+0.01*146 (total calorie)+0.5*11 g (protein)+0.5*12 g (dietary fiber)+0.02*541 g (adsorbed water)=29.4+1.46+5.5+6+10.8=53.

Calorie Cylinder Fullness Level=Total Calorie/10. For the standard meal (1Meal), its Calorie Cylinder Fullness Level=1000 calorie/10=100. For example, the calorie cylinder Fullness level of cauliflower is calculated: Calorie in 1 head of a medium cauliflower (588 grams) is 146 calories. Then, the calorie cylinder level of 1 cauliflower=146/1000=14.6 or 15. Because water in cauliflower is not free-flow water, its coefficient of 0.02 is unchanged.

Nutrient Cylinder Fullness Level=Nutrient measured amount/its 50% DRI value. The Nutrient Cylinder Fullness Level (vitamin C) for the standard meal (1Meal)=45 mg/(90/2) mg×100=100. The nutrient cylinder level of vitamin C in cauliflower is calculated: the amount Vitamin C in 1 head of a medium cauliflower (588 grams) is 283.4 mg, then its Nutrient Cylinder Fullness Level=283.4 mg/(90/2) mg=629.

From these above calculations, one can easily see that 1 head cauliflower is an excellent resource for vitamin C (as the nutrient cylinder fullness level is very high, 629), 53 for the gastrointestinal cylinder fullness, and a very lower for the calorie cylinder fullness level at 15. Therefore, for these who prefers to lose weight, this person should consume cauliflower more and often.

Utilizing this formula to calculate the meal cylinder fullness level of the published fullness data (from SlimFast Datasheet 2007), the results are listed in Table 1.

TABLE 1
Meal Cylinder Fullness Levels and No-Hunger Effect of Four Foods

| | Serving | | | | | Meal Cylinder | Time to |
|---|---|---|---|---|---|---|---|
| | Size | Calorie | Protein | Fiber | Water | Fullness | Feel Hunger |
| | (0.05) | (0.01) | (0.5) | (0.5) | (0.02) | Level | (min) |
| 1Meal (Added Standard) | 500 | 1000 | 80 | 40 | 250 | 100 | N/A |
| SlimFast | 330 | 190 | 10 | 5 | 284 | 32 | 292 |
| Yogurt | 330 | 190 | 7 | 0 | 288 | 28 | 215 |
| Bagel + Low Fat | 330 | 400 | 13.4 | 2 | 236 | 33 | 338 |
| Cream Cheese, | | | | | | | |
| Orange Juice | | | | | | | |
| Hamburger with Bun, | 351 | 400 | 23 | 0 | 266 | 38 | 250 |
| Small Soft Drink | | | | | | | |

Three out of the four meals had the agreeable fullness numbers. The last meal of hamburger with bun and a small soft drink, was disagreed dramatically. With such a high amount of protein and energy, this meal should have a much longer effect of fullness, unless that small soft drink had a strong effect to increase appetite, so the test subjects became hungry quicker than would be.

As defined, the Nutrient Cylinder Fullness Level for these nutrients on the current food label standard (fully match-over by consuming two standard, meals) are listed in Table 2. If a person can eat to 100% fullness with one standard meal, his daily nutrient requirement will be met by 50%, and the Nutrient Cylinder Fullness Level will be 100. If he can eat to 50% fullness with half of the standard meal, then his Nutrient Cylinder Fullness Level will be 50. Again, anyone has a good idea about his stomach fullness after one meal, much easier than measuring how many calories he consumed from one meal.

TABLE 2
Nutrient Fullness Cylinder at 100 and 50 levels

| | 50% Daily | | Nutrient | 25% Daily | | Nutrient |
|---|---|---|---|---|---|---|
| | Reference | | Fullness | Reference | | Fullness |
| Nutrient | Value | | Cylinder | Value | | Cylinder |
| Sodium | 1200 | mg | 100 | 600 | mg | 50 |
| Potassium | 1750 | mg | 100 | 875 | mg | 50 |
| Dietary Fiber | 12.5 | g | 100 | 6.25 | g | 50 |
| (optional) | | | | | | |
| Protein | 25 | g | 100 | 12.5 | g | 50 |
| (optional) | | | | | | |
| Vitamin A | 2500 | IU | 100 | 1250 | IU | 50 |
| Vitamin C | 30 | mg | 100 | 15 | mg | 50 |
| Calcium | 500 | mg | 100 | 250 | mg | 50 |
| Iron | 9 | mg | 100 | 4.5 | mg | 50 |
| Vitamin D | 200 | IU | 100 | 100 | IU | 50 |
| Vitamin E | 15 | IU | 100 | 7.5 | IU | 50 |
| Vitamin K | 40 | mcg | 100 | 20 | mcg | 50 |
| Thiamin | 0.75 | mg | 100 | 0.375 | mg | 50 |
| Riboflavin | 0.85 | mg | 100 | 0.425 | mg | 50 |
| Niacin | 10 | mg | 100 | 5 | mg | 50 |
| Vitamin B6 | 1 | mg | 100 | 0.5 | mg | 50 |
| Folate | 200 | mcg | 100 | 100 | mcg | 50 |
| Vitamin B12 | 3 | mcg | 100 | 1.5 | mcg | 50 |
| Biotin | 150 | mcg | 100 | 75 | mcg | 50 |
| Pantothenic acid | 5 | mg | 100 | 2.5 | mg | 50 |
| Phosphorus | 500 | mg | 100 | 250 | mg | 50 |
| Iodine | 75 | mcg | 100 | 37.5 | mcg | 50 |
| Magnesium | 200 | mg | 100 | 100 | mg | 50 |
| Zinc | 7.5 | mg | 100 | 3.75 | mg | 50 |
| Selenium | 35 | mcg | 100 | 17.5 | mcg | 50 |
| Copper | 1 | mg | 100 | 0.5 | mg | 50 |
| Manganese | 1 | mg | 100 | 0.5 | mg | 50 |
| Chromium | 60 | mcg | 100 | 30 | mcg | 50 |
| Molybdenum | 32.5 | mcg | 100 | 16.25 | mcg | 50 |
| Chloride | 1700 | mg | 100 | 850 | mg | 50 |

In the currently disclosed premix of hydrocolloids and nutrients to be used to double the volume/weight of the original food along with water, the amount of each nutrient is added to its 10% to 90% of the Daily Reference Value; preferably, 25% to 50% value, or 50 to 100 of Nutrient Cylinder Fullness Level, when the premix is mixed with the other parts of the ingredients to make the final food product. Hydrocolloids are included in the premix to meet the need for making a gelatinized food, such as the total hydrocolloids is from 0.1% to 10% in the final food product. Preferably, the total hydrocolloids will be within 0.5% to 5% in the final food product Or more preferably, the total hydrocolloids will be from 1% to 2% in the final food product.

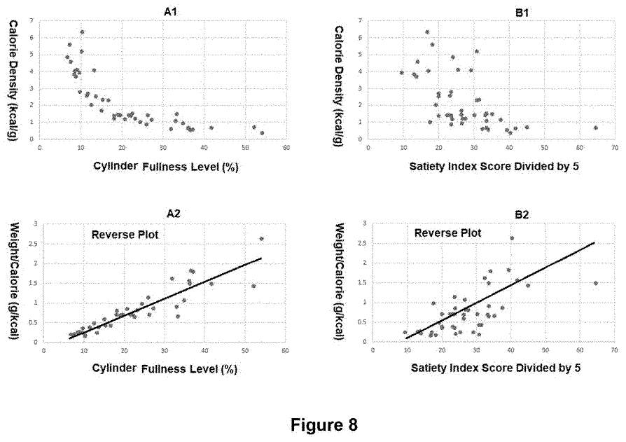

Utilizing the above created formula to calculate the meal cylinder fullness level of the published satiety index data (from an Australia study published in 1995), the results are shown in Table 3 and plotted in FIG. 8. The plots of the Calculated Meal Cylinder Fullness Level against Food Calorie Density have a much better reverse relationship, as compared to the plot using the published Satiety Index Score against Food Calorie Density. The newly invented tool shows a much better negative correlation relationship between Meal Cylinder Fullness Level v Food Calorie Density. This is an important new detection that these foods/meals with the high calorie density can easily cause an individual to over-intake calorie since those foods are less sensitive for being detected for the fullness effect in the gastrointestinal tract, mainly due to the smaller volume or smaller weight than the other foods with a lower calorie density in a higher volume.

TABLE 3
Relationship between the Meal Cylinder Fullness Level
and the published Satiety Index of the Common Foods

| | Serving | | | | | Meal Cylinder | |
|---|---|---|---|---|---|---|---|
| | Size | Calorie | Protein | Fiber | Water | Fullness | Satiety |
| | 0.05 | 0.01 | 0.5 | 0.5 | 0.02 | Level | Index |
| 1Meal | 500 | 1000 | 80 | 40 | 250 | 100 | N/A |
| Grapes | 395.0 | 240.0 | 3.2 | 3.6 | 317 | 32 | 248 |
| Bananas | 279.0 | 240.0 | 4.7 | 6.1 | 210 | 26 | 181 |
| Apples | 435.0 | 240.0 | 1.3 | 9.1 | 361 | 37 | 248 |
| Oranges | 625.0 | 240.0 | 6.9 | 12.5 | 539 | 54 | 309 |
| White Bread | 94.0 | 240.0 | 8.5 | 3.3 | 6 | 13 | 77 |
| Croissant | 61.0 | 240.0 | 6.1 | 1.8 | 14 | 10 | 67 |
| Cake | 64.0 | 240.0 | 4.3 | 0.7 | 11 | 8 | 92 |
| Doughnuts | 65.0 | 240.0 | 4.3 | 1.4 | 16 | 9 | 95 |
| Cookies | 51.0 | 240.0 | 2.4 | 1.0 | 2 | 7 | 168 |
| Crackers | 58.0 | 240.0 | 5.8 | 1.6 | 2 | 9 | 179 |
| Mars Bar | 54.0 | 240.0 | 2.9 | 1.7 | 4 | 7 | 76 |
| Yoghurt | 241.0 | 240.0 | 11.8 | 0.5 | 187 | 24 | 91 |
| Ice Cream | 120.0 | 240.0 | 5.2 | 0.0 | 74 | 12 | 95 |
| Jellybeans | 88.0 | 240.0 | 5.3 | 0.0 | 12 | 10 | 104 |
| Peanuts | 38.0 | 240.0 | 9.6 | 2.4 | 1 | 10 | 128 |
| Chips | 44.0 | 240.0 | 2.7 | 2.4 | 1 | 7 | 99 |
| Popcorn | 47.0 | 240.0 | 4.6 | 6.2 | 2 | 10 | 167 |
| Cheese | 59.0 | 240.0 | 15.0 | 0.0 | 21 | 13 | 181 |
| Eggs | 159.0 | 240.0 | 19.6 | 0.0 | 119 | 23 | 185 |
| Lentils | 253.0 | 240.0 | 19.4 | 11.4 | 222 | 35 | 164 |
| Baked Beans | 351.0 | 240.0 | 16.1 | 16.8 | 267 | 42 | 208 |
| Beef Steak | 158.0 | 240.0 | 42.0 | 0.0 | 104 | 33 | 218 |
| Ling Fish | 333.0 | 240.0 | 56.3 | 0.0 | 250 | 52 | 278 |
| White Bread | 94.0 | 240.0 | 8.5 | 3.3 | 36 | 14 | 77 |
| Wholemeal Bread | 101.0 | 240.0 | 7.6 | 6.6 | 40 | 15 | 121 |
| Grainy Bread | 108.0 | 240.0 | 9.4 | 6.5 | 41 | 17 | 119 |
| White Rice | 203.0 | 240.0 | 5.0 | 0.4 | 140 | 18 | 106 |
| Brown Rice | 148.0 | 240.0 | 5.2 | 1.4 | 94 | 15 | 101 |
| White Pasta | 201.0 | 240.0 | 7.7 | 3.5 | 135 | 21 | 101 |
| Brown Pasta | 218.0 | 240.0 | 11.3 | 10.9 | 133 | 27 | 145 |
| Potato | 368.0 | 240.0 | 10.0 | 9.2 | 291 | 36 | 248 |
| French Fries | 93.0 | 240.0 | 3.9 | 3.5 | 34 | 11 | 89 |
| Cornflakes | 170.0 | 240.0 | 8.4 | 1.5 | 111 | 18 | 140 |
| Special K | 172.0 | 240.0 | 15.3 | 1.4 | 111 | 22 | 138 |
| Honeysnacks | 172.0 | 240.0 | 8.7 | 2.6 | 115 | 19 | 157 |
| Sustail | 168.0 | 240.0 | 9.7 | 3.2 | 119 | 20 | 133 |
| Muesil | 175.0 | 240.0 | 10.7 | 6.6 | 114 | 22 | 119 |
| Porriage | 383.0 | 240.0 | 10.9 | 4.7 | 334 | 36 | 247 |
| All-Bran | 174.0 | 240.0 | 11.7 | 14.1 | 111 | 26 | 180 |

Also shown in FIG. 8, the plots of the Calculated Meal Cylinder Fullness Level v Food Calorie Porosity (weight/calorie) have a much better positive correlation relationship, as compared to the plot using the published Satiety Index Score v Food Calorie Porosity. The newly invented tool shows a much better positive correlation relationship between Meal Cylinder Fullness Level v Food Calorie Porosity. Volume counts! This is highly agreeable to the Volumetrics published by Dr. Barbara Rolls at Pennsylvania State University and broadly used in weight loss practice worldwide.

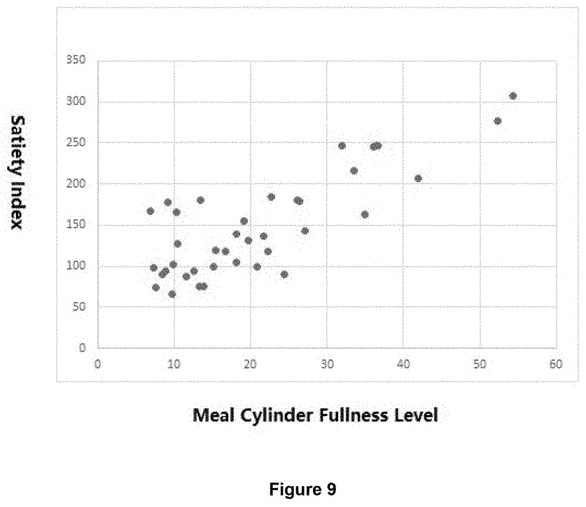

As shown in FIG. 9, the newly calculated Meal Cylinder Fullness Level and the published Satiety Index are highly positively correlated. This plot indicates that the usefulness of the Meal Cylinder Fullness Level is at least agreeable with the published Satiety Index. It is much simpler to remember these numbers from 1 to 100 instead of these big numbers in hundreds.

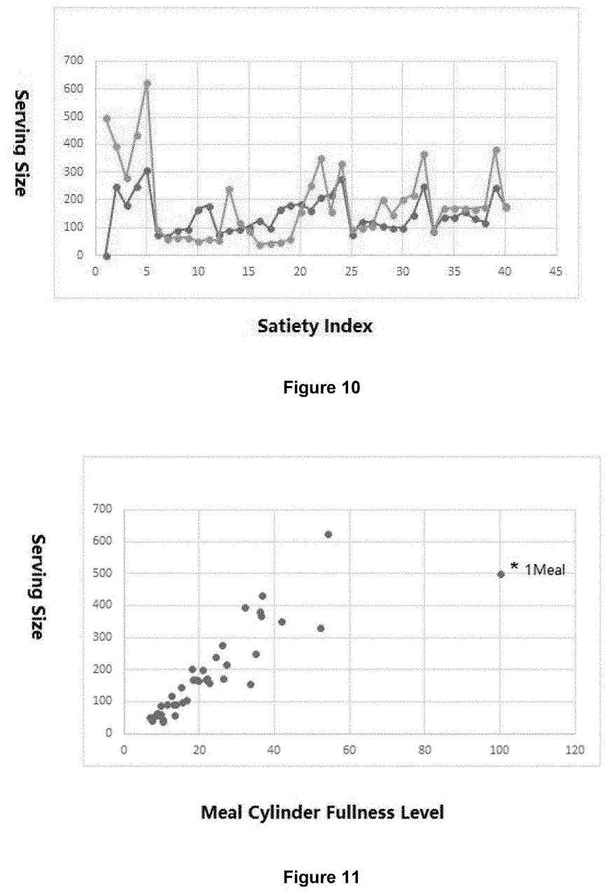

As shown in FIG. 10, there is a correlation relationship between the meal serving size and the published Satiety Index. This plot indicates that there is a generally agreeable relationship between the two sets of the data.

FIG. 11 shows that the relationship between the newly calculated Meal Cylinder Fullness Level and the meal serving size using the 1995 published data. This plot indicates that the Meal Cylinder Fullness Level is highly correlated with the meal serving size.

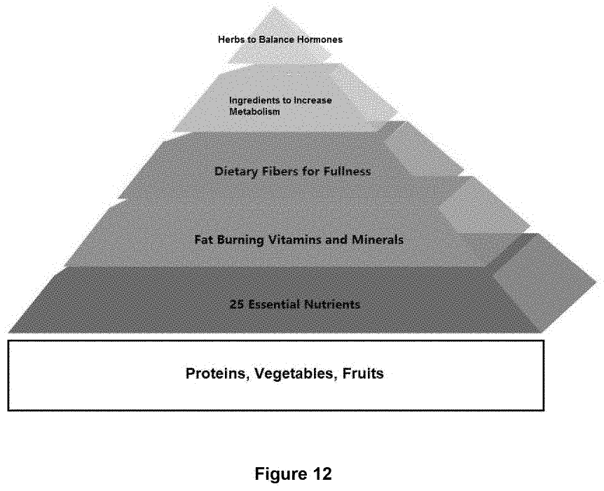

FIG. 12 shows that the relationship between the newly calculated Meal Cylinder Fullness Level and the meal serving size. This plot indicates that the Meal Cylinder Fullness Level is highly correlated with the meal serving size.

It is simple and easy to use the invented methods to manage body weight without hunger. Unlike dieting, the current weight management will have no risk for nutritional inadequacy or deficiency. Any food material can be processed to become a weight gain, weight loss or weight maintenance product. The key is the propositions of the calorie and non-calorie ingredients in the final product. The standard food/meal is to keep the body weight unchanged since it provides a very balanced calorie, nutrients for fullness.

To make it a weight loss product, the calorie cylinder fullness level should be lower than the standard food/meal. To make it a weight gain product, the calorie cylinder fullness level should be higher than the standard food/meal. In both ways, the user can happily eat to the fullness without hungry.

For foods came from the animal meat, its original calorie cylinder fullness level is higher. The calorie density can be diluted with vegetable, fruit, water-soluble fiber, and water, then the meat becomes a part of the lower calorie density foods. The calorie cylinder fullness level of the meat will then be just kept at the right level for keeping the body weight within the normal range. Several new food items made from chicken gained the characters of low calorie and high nutrition with a high meal cylinder fullness level. The economic value of the chicken is greatly increased as the new food products made from one chicken can be used to feed 14 people to their 100% fullness, instead of just meeting two people's fullness with the original one chicken. The same economic value gain can be realized for one-pound pork or one-pound beef, as well as the other meats.

Soft drink industry and liquid nutrition companies can utilize the current technology to significantly increase the product's economic value by doubling the volume of the original container after adding the premix of hydrocolloids and nutrients, and water, as disclosed in the current invention. For example, one can of SlimFast liquid diet, after adding the premix of hydrocolloids and nutrients, and water, become two cans, each with the 50% calorie content but the same level of nutrients, and the original liquid becomes gelatinized food to gain a much higher effect of satiation and satiety than its original. As a result, new SlimFast-type product will become more cost-effective in reducing body weight. The same advantages can be obtained for Campbell's soups, and many fruit juices. Their satiation and satiety effects will be at least doubled after being changed from the liquid form to the gelatinized form with double volume. Fresh fruits or vegetables, after being processed for having 2-times volume/weight using the newly disclosed technology, will become at least 200% effect as compared to their original.

If for gaining body weight, one either can select the food with the calorie density high, food, or even to change a vegetable with a lower calorie cylinder to have a high calorie cylinder by adding more ingredient with a high calorie cylinder level, such as fried eggplant. The general public can use this simple system and their own sensitivity in stomach fullness to manage their body weight.

Collectively, the meal cylinder, calorie cylinder, nutrient cylinder, either made in one dimensional, two or three dimensional, are forming a Meal Cylinder Fullness (MCF) System. This MCH system links a person's fullness directly with what he/she consumed, so he/she can measure the food quality and quantity by his/her direct human sense, an innate capacity inherited from thousands of generations. When the current invention is fully utilized, the human society can become healthier and more fit.

It is recommended for the government and for the food industry to evaluate and then adapt this new method of Meal Cylinder System for food labeling. Using the newly disclosed tool in expressing the quality and quantity of a food or a meal, consumers now have a much easier way to know which food/meal and how much should be consumed to meet his/her special purpose in weight management. Weight control becomes an enjoyable and easy practice.

For a national and international collaboration in fighting and winning the war against obesity, we provide a variety of new foods with a high nutrition but low calorie. In addition, these individual food items listed in the huge database of the United States Department of Agriculture, Agricultural Research Service, USDA Food Composition Databases https://ndb.nal.usda.gov/ndb/search/list can be easily changed to the Meal Cylinder Fullness Level by using a new computer program which is to be created based on the formula used in this invention. The FDA's food label guideline should also be changed as the format of Meal Cylinder Fullness Level to ease the actual use of the food labels. Obviously, for general public, the different units of nutrients, such as grams, milligrams, micrograms, international units, are very hard to remember or to use. Most people can tell if his or her stomach is full or not, or how much of the fullness, from 0 to 100 percent.

What we disclosed below will serve as examples for the others to have more choices of selecting ingredients and formulations to get the desired new foods and meals with big volume to be used to manage their body weight.

In one aspect, the present invention provides a composition comprising these essential nutrients, such as vitamins and minerals, for supporting normal body metabolism, and for burning fat. This is to ensure that the user will not have a risk to have non-adequate nutrients during the time period of weight loss by eating less. The newly created products must be complete in nutrition to overcome the shortage of the natural food products. This portion of the composition alone can be used as a food/diet/nutritional supplement. The user will have no need to use additional nutritional supplement product.

In another aspect, the present invention provides a composition comprising these factors to facilitate fat metabolism, such as vitamin C and vitamin D. This is to ensure that the user will have a boost in utilizing the body's fatty tissue to supply energy during weight loss period.

In another aspect, the present invention provides a composition comprising these dietary factors to inhibit adipogenesis. One of these facts is Fucus Vesiculosis.

In another aspect, the present invention provides a composition comprising these factors to facilitate fat metabolism, such as vitamins and minerals. This is to ensure that the user will have a boost in utilizing the body's fatty tissue to supply energy during weight loss period.

In another aspect, the present invention provides a composition comprising these factors to increase calorie utilization, such as Cayenne peppers.

In another aspect, the present invention provides a composition comprising these factors to increase fat burning, such as an herb, like Coleus Forskolin.

In another aspect, the present invention provides a composition comprising these factors to restore an individual's energy, such as Ashwagandha.

In another aspect, the present invention provides a composition comprising these factors to balance stress and energy related hormones, such as Schisandra.

In another aspect, the present invention provides a composition comprising these factors to reduce fat absorption, such as Kelp.

In another aspect, the present invention provides a composition comprising these factors to fulfill the gastrointestinal tube so the user will not feel hungry during weight loss process.

In another aspect, the present invention provides a composition comprising B vitamins (Vitamin B1, B2, B6, B12, Biotin, Folic acid) to help in energy metabolism. Vitamin B1 and B2, B6 can speed up fat burning in the human body. Fat loss happens when the individual has an energy deficit caused by eating fewer calories than one burned. In some cases, a vitamin deficiency can make an individual feel sluggish and cause an uptick in hunger-causing hormones, making one gain body weight. Correcting these deficiencies can gradually help one return to a healthier weight. Adequate intake of B vitamins helps stave off weight gain. Many published studies showed that people who consistently took supplements of multivitamins, vitamins B6 and B12 experienced less weight gain over 10 years compared to people who did not take the supplements. In the newly created weight loss products, any B vitamin is added from 30% up to the upper limit (UL) of the recommended daily intake for nutrients to adequately support the metabolism towards weight loss.

In another aspect, the present invention provides a composition comprising vitamin C. Vitamin C can be found in abundance in citrus fruits, kiwi fruit and red bell peppers acts as an antioxidant and supports tissue development, immunity and fat and protein metabolism. Overweight and obese people tend to have lower levels of vitamin C. Getting adequate amounts of the vitamin is essential to health and energy, and it plays an essential role in calorie burning. In We disclosed new Food™, vitamin C is adequately provided to ensure your health during weight loss.

In another aspect, the present invention provides a composition comprising these factors to use fat as energy, such as lysine.

In another aspect, the present invention provides a process on how to make the composition comprising these factors to lose weight to be commercially viable products. The processes include the technologies of homogenization and taste enhancement.

In another aspect, the present invention provides a method on how to use the composition comprising these factors to lose weight during daily life.

In another aspect, the present invention provides a composition comprising vitamin D. Low vitamin D levels cause your body to set a higher weight set point and increase the release of hunger-stimulating hormones. It has been determined by research that 12 weeks of supplementing a low-calorie diet with calcium and vitamin D3 enhanced weight loss compared to a low-calorie diet alone. The overweight and obese college-age participants reported low levels of calcium intake prior to beginning the study. In We disclosed new food, vitamin D is provided to support the healthy weight loss.

In another aspect, the present invention provides a composition comprising minerals. Like the B vitamins, certain minerals also play a role in breaking down nutrients into energy, including iron, copper and chromium. Both iron and copper play an essential role in metabolism, working in your cells turning food into energy. You will feel tired if you lack either one of these nutrients. Getting enough minerals is needed for a health weight loss. Chromium is a trace mineral found in a number of weight-loss supplements. This mineral improves insulin activity and also metabolizes fat, protein and carbs. In We disclosed new Food™, these essential minerals are provided to ensure you will be well-nourished during the process of eating less for weight loss.

In another aspect, the present invention provides a composition comprising other vitamins and minerals. Other vitamins and minerals, although do not directly involve energy metabolism, they are essential for your overall health. When you consume We disclosed new food, one will have experience less food intake desire. Without supplement of these essential nutrients, one could have a risk of nutrition deficiency. Therefore, what we disclosed new food provides these essential vitamins and minerals, such as vitamin A, niacin, folic acid, calcium, magnesium, etc. Including these essential nutrients is to protect the user's overall health during the weight loss period. Any products used for weight loss without providing these essential nutrients are defect in terms of protecting one's overall health.

In another aspect, the present invention provides a composition comprising glucomannan. Glucomannan, a natural dietary fiber, proven to be effective for weight loss with several human studies. Glucomannan is a natural, water-soluble dietary fiber extracted from the roots of konjac. Like other soluble fibers, glucomannan absorbs water in the stomach and contributes to satiety. It may also promote reduced calorie intake and weight loss via several other mechanisms. Several randomized controlled trials on glucomannan showed that it worked in reducing body weight. Glucomannan is used here to reach the daily consumption goal of the American Dietetic Association (ADA) for dietary fiber: ADA recommends that people consume 20 to 35 grams of fiber per day, of which 5 to 10 grams should be soluble fiber. However, Americans typically average only about 12 to 17 grams of total fiber and only 3 to 4 grams of soluble fiber a day. We disclosed new gelatinized food is to supply 6 grams of soluble fiber a day. Glucomannan and/or its premix can be frequently used with water to double the volume of the original food, such as soups, soft drinks, liquid nutrition, etc. by adding adsorbed water, not free water.

In another aspect, the present invention provides a composition comprising Schizandra. The very name of Schizandra in Chinese, Wu Wei Zi, tells us a great deal about the qualities of this herb. Wu Wei Zi means “Five Flavors Fruit.” Due to the fact that Schizandra possesses all five of the classical “tastes” (sour, bitter, sweet, spicy and salty) and thus possesses the essence of all five of the elemental energies (wood, fire, earth, metal and water). Schizandra is respected as a health-providing tonic in the same class with Ginseng, Reishi and Goji. As the well-known Dr. Axe said, schisandra, known as an adaptogenic agent, helps balance hormones naturally and therefore improves our ability to deal with stressors, both physical and psychological. Schisandra has been used for thousands of years to naturally raise the body's resistance to environmental stress, anxiety, toxin exposure, emotional trauma, mental fatigue and mental illnesses. Because schisandra helps nurture the adrenal glands and turns down an overproduction of “stress hormones” like cortisol; it's linked with better mental capabilities, physical endurance and metabolic health. Schisandra is used here to help maintain your energy level during one's weight loss time.

In another aspect, the present invention provides a composition comprising Coleus forskolin. There were notable differences between obese and normal weight humans, as obese persons seem to have lower activity adenylate cyclase enzymes in fat cells, which is partially corrected upon weight loss via caloric restriction (Martin LF1990). Coleus forskohlii is used as a fat burning supplement. The main bioactive ingredient in Coleus forskohlii is called forskolin which is to increase testosterone; and protect against cancer and inflammation. Forskolin increases cellular levels of a molecule called cyclic adenosine monophosphate (cAMP). Elevated cAMP levels are associated with increased rates of fat loss, and can improve the effects of other fat. The human study in overweight women noted that two doses of 250 mg reduced weight gain (Henderson S 2005). In overweight men, the same dose appears to cause favorable changes in body composition over a period of 12 weeks (Godard M P 2005). Testosterone and bone mass were also increased in the Coleus Forskohlii group. One study that did not investigate weight changes primarily noted that over a period of 2 months with 500-700 mg Coleus Forskohlii; there was a 2.38-2.6% reduction in BMI (Jagtap M 2011).

In another aspect, the present invention provides a composition comprising lysine. Lysine is one of eight essential amino acids—building blocks of protein—that the body cannot manufacture on its own, L-lysine helps to produce carnitine, a substance that converts fatty acids into energy and lowers levels of LDL (“bad cholesterols”) in the bloodstream. In addition, l-lysine benefits the skeletal system by contributing to the production of collagen, the protein used to make bone, tendons, cartilage and connective tissue. Calcium absorption and use is also facilitated by l-lysine, and l-lysine benefits the skin by helping to maintain its health and elasticity.

In another aspect, the present invention provides a composition comprising Kelp. Nutritional Benefits of Kelp as it absorbs the nutrients from its surrounding marine environment in the sea, kelp is rich in vitamins, minerals, trace elements and enzymes, such as iron, manganese, calcium, magnesium, copper, zinc, niacin, vitamins A, B1, B2, B-12, 8-6, and C. Kelp “is often considered a ‘superfood’ due to its significant mineral content. It's especially concentrated in iodine, which is important for optimal thyroid function and metabolism.” The National Institutes of Health (NIH) claims that seaweed such as kelp is one of the best natural food sources of iodine, an essential component in thyroid hormone production. A deficiency in iodine leads to metabolism disruption and can also lead to an enlargement of the thyroid gland known as goiter.

Furthermore, kelp contains a natural fiber called alginate, studies suggest that it may halt the absorption of fat in the gut. A study published in Food Chemistry found that alginate could help block fat absorption in the intestines by 75 percent. Kelp may have great potential for diabetes and obesity, although research is still preliminary. A study published in the journal Diabetes, Obesity and Metabolism found that a compound in the chloroplasts of brown seaweed called fucoxanthin may promote weight loss in obese patients when combined with pomegranate oil. Studies also suggest that brown seaweed may influence glycemic control and reduce blood glucose levels, benefitting people with type 2 diabetes.

In another aspect, the present invention provides a composition comprising Ashwagandha root. If you are looking to restore your energy, look younger, and reverse disease then ashwagandha may be the herb you're looking for. As you're about to see, ashwagandha benefits are impressive. Ashwagandha, is an adaptogenic herb popular in Ayurvedic medicine that has shown incredible results for lowering cortisol and balancing thyroid hormones. In India, ashwagandha is known as the “strength of the stallion” since it has traditionally been used to strengthen the immune system after illness. Ashwagandha has also been referred to as Indian ginseng because of its ability to enhance stamina and has extraordinary stress relieving properties. There have been over 200 studies on Ashwagandha's ability to: improve thyroid function, treat adrenal fatigue, reduce anxiety and depression, combat effects of stress, increase stamina and endurance, prevent and treat cancer, reduce brain cell degeneration, stabilize blood sugar, lower cholesterol, boost immunity. Ashwagandha has also been proven effective in supporting adrenal function helping you overcome adrenal fatigue and chronic stress. Medical studies have shown that ashwagandha improves cortisol levels, improves insulin sensitivity and naturally balances hormones.

In another aspect; the present invention provides a composition comprising Bladderwrack. Bladderwrack (formal name Fucus Vesiculosis) is a brown seaweed which is a good source of iodine (the mineral needed for proper thyroid function) and of various i″-fucose compounds. These L-fucose compounds can be seen as generally being anti-obesity, anti-inflammatory, anti-oxidant, and anti-carcinogenic. There are also some implications of them being anti-viral and anti-diabetic. Bladderwrack is most commonly known for its pro-thyroid effects, which may be confounded by it being the first discovery of iodine (of which a deficiency causes goitre) (Moro Col. 2000).

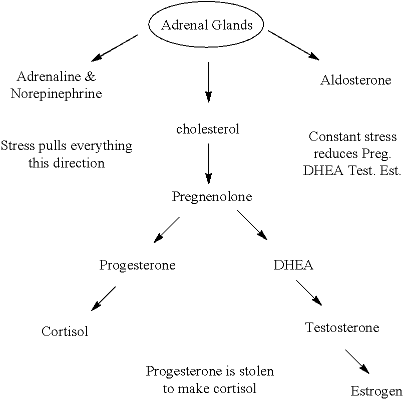

In another aspect, the present invention provides a composition comprising cayenne peppers, Cayenne peppers are closely related to jalapeño peppers and bell peppers and are a staple in Southwestern American and Mexican cuisine, as well as Cajun and Creole cooking. The thin red pepper has a deceptively mild smell but packs a powerful fiery taste. Cayenne peppers are often dried and ground to make a powdered spice used for seasoning. The peppers are also used in their whole form in Korean, Sichuan, and other Asian cuisines. Capsaicin, the active ingredient in cayenne peppers, gives the powder its spiciness and is used to treat aches and pains of the muscles and joints. Cayenne pepper has also been used in traditional Chinese and Ayurvedic medicines to help treat circulatory problems and increase appetite.

There are many products containing cayenne pepper that claim to boost metabolism and promote weight loss. Researchers found that cayenne pepper consumption increases body temperature slightly, which would, in turn, burn calories. The results of the research revealed that those who mixed cayenne pepper with their food burned an additional 10 calories 4 hours after eating their meal compared with those who did not add cayenne.

The factors that determine how many calories your body burns in a day includes body size, gender, genetics, food intake and physical activity, with food intake and physical activity being the only two you can manage. Consuming more We disclosed new gelatinized food resulted in the faster weight loss; and combined with more physical activities will speed up your weight loss. However, the beauty of We disclosed new gelatinized food is that although physical activities helps weight loss even further when combine with We disclosed new Food™ it is NOT required. Drinking We disclosed new gelatinized food alone will deliver the result as you desire. For the people whose BMI (Body Mass Index) is over 30, losing body weight by 0.5 lb daily is a recommended speed. For those whose BMI is over 25 but below 30, losing body weight by 0.25 lb daily is recommended. Losing body weight too fast may cause you to feel “not-used to.” For the first two weeks, you should drink We disclosed new gelatinized food three times a day, each time before any of the three meals. After the fast speed of losing body weight for the first two weeks, you may slow down the speed of weight loss as desired by drink We disclosed new gelatinized food two times a day.

For increasing your speed of weight loss, you can increase your physical activity while you are consuming We disclosed new Food™. You can simply improve your metabolism by taking the stairs, standing while you work, pacing when on the phone, and parking far from the entrance. Aerobic activity, such as running or step-class, gets your heart rate up and burns calories. Muscle is a more efficient calorie-burner than fat tissue, and adding muscle to your exercise frame gives your resting metabolism a slight boost. As we all know, any physical exercises surely help, however, not required to lose weight when consuming We disclosed new Food™.

In the current marketplace, there are numerous products, including prescription drugs, are not ideal products for healthy weight loss. Human body is a very complicated system, body weight change is highly regulated. One single factor, like one dietary fiber, cannot cause a healthy weight loss. One dietary supplement, such as L-lysine, or even that strong spicy Cayenne Pepper, cannot be used alone to achieve a natural weight loss. Simply, these products are not food, and does not come with very needed essential nutrients. One dietary supplement, so far, cannot be called ideal product for weight loss. We disclosed new gelatinized food is a combination of more than 10 dietary supplements and more than 20 nutrients. The right combination and proportion of each is to enable the consumer to drink soup naturally before any meal. We disclosed new gelatinized food represent a new weight loss pyramid that is healthy, effective, and natural. The bottom level includes nutrients; the 2^{nd} level, fat burning vitamins and minerals; the 3^{rd} level dietary fibers to have a Volumetrics effect for you not to feel hunger, the 4^{th} level are natural ingredients with proven successful history in weight loss to boost, metabolism; the 5^{th} and the top level are these specially selected herbs to balance hormones and control your body weight. Shown as in FIG. 12.

Using the current invention, we can improve the popular foods in the marketplace from promoting weight gain items to become a weight loss items. First is a group of these common soups.

Soup is the comfort and tasty food. Some of them can add to anyone's total calorie and fat intake largely. This doesn't mean you have to give up your favorite cold-weather soup. Just improve them listed below, and make then for benefiting your health.

1. Clam chowder. Anything with the word “chowder” in it is probably going to be high in cream, fat, and calories. The famous Campbell's Chunky New England Clam Chowder is with 230 calories per serving, 13 grams of fat, and 890 milligrams of sodium. Plus, each can contains two servings, so if you eat them at the same time, you're up to 1,780 grams of sodium. Adding our premix of hydrocolloids and water in a total amount of 3 times of the original soup, then the calorie for each serving will become 25% of the original, or less than 80 calories per serving. In addition, the new soup will be in gelatinized format, and the satiation and satiety effect will be at least 4 times higher than the original soup. Therefore, one meal become 4 meals and gained 4-times effect of satiation and satiety as compared to its original. Now it is easy to change clam chowder from a weight gain promoting item to a weight-loss promoting item.

2. Potato soup. Potato soup can be healthy, but it's often made with a cream base instead of a broth base, which means that it, like the chowder, can be loaded with calories and saturated fat. Adding our premix of hydrocolloids and water in a total amount of 3 times of the original potato soup, then the calorie for each serving will become 25% of the original per serving. In addition, the soup will be in a jelly format, and the satiety effect will be at least 4 times higher than the original soup. Therefore, one meal become 4 meals for the 4× high effect of satiation and satiety.

3. Lobster bisque. With an average of 13.1 grams of fat (that's 20 percent of the daily recommended serving), most of it saturated, and 896 grams of sodium, this is a definite a to be avoided item for diet if not improved. Adding our premix of hydrocolloids and water in a total amount of 3 times of the original Lobster bisque soup, then the calorie for each serving will become 25% of the original per serving. In addition, the soup will be in a jelly format, and the satiety effect will be at least 4 times higher than the original soup. Therefore, one meal become 4 meals for the 4× high effect of satiation and satiety.

4. Broccoli and cheese soup. Soup using broccoli as a base is healthy. Most restaurant versions tend to feature a few tiny broccoli florets drowning in a bowl of cheese, not good for weight loss. Adding our premix of hydrocolloids and water in a total amount of 3 times of the original soup, then the calorie for each serving will become 25% of the original per serving. In addition, the liquid soup will be in a gelatinized format, and the volume will be 4 times higher as compared to the original soup. Therefore, one meal become 4 meals for the 4× high effect of satiation and satiety.

Improved liquid nutrition. Losing weight is a common goal of using the liquid nutrition. One category of weight loss diets emphasizes the consumption of these liquid nutrition. Some programs simply replace certain meals with liquids, while others replace all solid foods with liquids. However, the main weakness of the, liquid diets is to cause the user to quickly resume eating since these liquid foods move through the gastrointestinal track very fast. Their fullness effect must be improved. Using the disclosed technology, one liquid meal become 2 meals for the 2× high effect of satiation and satiety.

Improved Meal Replacements. Some liquid diets involve meal replacement shakes, which are consumed in place of solid foods. Numerous companies sell these shakes for weight loss purposes. Meal replacement shakes are often lower in calories than typical meals. They can replace one or multiple meals each day. They are designed to contain all the nutrients your body needs to function, including macronutrients (protein, carbs and fat) and micronutrients (vitamins and minerals). Some weight loss programs use these shakes to account for your entire calorie intake for up to several months. Adding our premix of hydrocolloids and water in a total amount of doubling the original liquid nutrition, then the calorie for each serving will become 50% of the original per serving. In addition, the liquid will be in a jelly format, and the satiety effect will be at least 2 times higher than the original liquid. Therefore, one serving become 2 servings for the higher fullness level. SlimFast and Ensure Light, for example, can be improved in this way, for being more effective food items in weight loss. Using the disclosed technology, one liquid meal become 2 meals for the 2× high effect of satiation and satiety.

Improved Soft Drinks. It was estimated that, two cans or glasses of regular soda per day adds approximately 24 to 35 pounds of body weight per year, depending on body size, age, habits, etc. There is a popular strategy for losing weight by consuming soft drinks for zero-calorie diet soda. However, these diet drink cannot satisfy the need of feeling full. Losing weight with hunger is not a happy way and it is easy to fail. Adding our premix of hydrocolloids and water in a total amount of doubling the original soft drink, then the calorie for each serving will become 50% of the original per serving. In addition, the liquid will be in a jelly format, and the satiety effect will be at least 2 times higher than the original soft drink. Therefore, one serving become 2 servings for the higher fullness level. Diet Coke and Diet Pepsi, far example, can be improved in this way, for being more effective in weight loss, and in satisfaction for feeling fullness, in addition to meeting the need for rehydration, the primary usefulness of the soft drink. Using the disclosed technology, one soft drink become two gelatinized foods for more than 2× higher effect of satiation and satiety than its original, which is more beneficial for weight loss.

Improved Fruit and Vegetable Juice. These juices, like soft drinks, have less effect of satiety. Adding our premix of hydrocolloids, premix of nutrients, and water in a total amount of doubling the original juices, then the nutrients for each serving will not be reduced from the original serving volume. In addition, the juice will be in a jelly format, and the satiety effect will be at least 2 times higher than the original juices. Therefore, one serving become 2 servings for the higher fullness level. Orange juice, apple juice and many vegetable juices can be improved in this way, for being more effective in weight loss, and in satisfaction for feeling fullness, in addition to meeting the need for rehydration and nutrition. Using the disclosed technology, one can of the fruit or vegetable juice become two gelatinized foods for more than 2× higher effect of satiation and satiety than its original, which is more beneficial for weight loss.

What we disclosed here can be in several formulations, such as premix of the condensed liquid to be added to the other foods, premix of the powder to be added to the other foods, either liquid or semiliquid food, or solid food, like salad. The new foods item can also be manufactured as the ready-to-use either as a liquid or a solid. Many food processing and packaging methods taught in the prior arts can be utilized here to make the new foods. Individual serving unit can be packed in a bag, or tube, a bottle, a jar, or any type of food container. Here, we prefer to use a new package of a tube, with an inside removable bottom and a cap. The jelly is packed in this tube-like container. When the bottom is pushed in, the jelly comes out for easy consumption.

Using what we disclosed new food to lose weight, one has no extra work, only 1 simple step—start everyday meal with the new food—high nutrient and low calorie in a bigger volume than before, to feel fully full. There is no hunger, no suffering dieting, no change to the routine life at all. It offers a 1-step natural healing of the body weight and it is so simple that even with one's busy life, losing weight is manageable. What we disclosed holds the promise to deliver the weight control result without hunger, a dream way. It is very easy to lose 3-5 lbs per week and keep the weight off permanently.

With our new foods, one can set a goal of reaching the desired weight, and work toward that goal and see the result in one week. What we disclosed is the solution for fast, big and sustained weight loss. One can improve the life quality and gain well deserved good life back with our new foods. Without changing the current lifestyle—eat the same type of food as one normally does, just a little less calorie since no such hunger will surface after using our new foods with a big volume. If you work out, you can continue the same; if don't work out, you can also continue the same; and etc. No calorie counting; no dieting; no meal plan; no food shopping list; the process of natural weight loss with what we disclosed is as enjoyable and as easy as one can imagine. It is easy and quick for anyone to try to see the results. It is easy now to be healthier, leaner and happier using what we disclosed.

Furthermore, you can just replace partially two meals with what we disclosed for feeling full. You can have one favored shakes, bars or cookies, enjoy one sensible meal of your choice. This way your fat is burning, and no need go hungry and don't miss out your favorite foods.

For maximum results, you should avoid sugar-sweetened beverages like juice and sodas. They will slow down your weight loss and make you tired. Drink plenty of water and get in 30 minutes of daily exercise. You'll burn calories, gain lean muscle mass and release feel-good endorphins that will keep you smiling all the way to your targeted weight. For weight loss or weight control, the composition, in any form as described, can be ingested before, during or after each meal or any other food ingestion, e.g., breakfast, a snack, etc. The big volume of the new food with, a high nutrients and low calorie make your job very easy.

In another aspect, the present invention provides a premix of hydrocolloids and vitamins and minerals, including electrolytes. The quantity of each functional ingredient is dependent on its role to be played in the new food. For these nutrients or electrolytes with the recommended daily intake, their quantity should be within the range of 10% to 100% of the recommended usage. For these hydrocolloids, they do have the daily recommended use dose since they are counted as dietary fiber. Generally, their quantity should be no more than 100% of the daily recommended usage as fibers. However, their quantity is added for forming jelly-like food products and that usage can be below what was recommended for the daily fiber intake. Particularly, when the two or more hydrocolloids are added together in the premix for their synergy in forming gel, their use can be decided per the published data of use as the jellying agent. For example, the hydrocolloid can be at the weight or volume less than about 50% of the recommended daily fiber use, or in other embodiments, less than about 40%, less than about 30%, less than about 20%, less than about 10%, less than about 5%, less than about 1%, less than about 0.5%, or less than about 0.1% of the recommended daily dose for dietary fiber.

Hydrocolloids, preferred with prebiotic activity, such as oligosaccharides or glucomannan, xanthan gum, carboxymethyl cellulose (CMC), methyl cellulose, hydroxypropylmethyl cellulose, gum Arabic, galactomannans, glucomannan, gum tragacanth, agar, modified starch, carrageenan, low or high methoxy pectin, gellan gum, alginate, methyl and hydroxypropylmethyl cellulose, collagen, to hold water to increase the volume of the food to increase the gastrointestinal tract cylinder fullness level, and to enable the user to reach fulness for a relatively longer time of period, within a safe and effective range, such as 0.1 to 5%. The synergy between and among these hydrocolloids is a big advantage for producing the new food to be a 2× bigger volume than the original, which is gaining the stronger effect of satiation and satiety due to the new gelatinized format than the original liquid formulation.

In some embodiments, the premix of fibers and nutrients can include water insoluble and water soluble dietary fibers, such as resistant starches, non-resistant starches, and non-starch polysaccharides. Examples include arabinoxylans, cellulose, dextrins, inulin, lignin, waxes, chitins, pectins, beta-glucans and oligosaccharides, including galactosaccharides and fructo-oligosaccharides, cellulose or derivatives of cellulose like methyl cellulose, ethyl cellulose, and/or methyl-ethyl cellulose, or fibers extracted from Aloe vera, Basella alba (Malabar spinach), Cactus, Chondrus crispus (Irish moss), Dioscorea opposite (Nagaimo, Japanese mountain yam), Drosera (sundews), fenugreek, flax seeds, kelp, liquorice root, marshmallow, mullein, okra, Parthenium, Pinguicula (butterwort), psyllium seed husks, Salvia hispanica (chin) seed, Ulmus rubra bark (slippery elm), or any other suitable plant. Other polysaccharides include etheropolysaccharides like pectines. Gums, such as those that may be obtained from seaweeds and other sources. Such compounds include polyelectrolytesagar (E406), alginic acid (E400) and sodium alginate (E401), and Carrageenan (E407). Natural gums obtained from non-marine botanical resources include polyelectrolytes: gum arabic (E414) from the sap of Acacia trees, gum Bhatti from the sap of Anogeissus trees, gum tragacanth (E413) from the sap of Astragalus shrubs, and karaya gum (E416) from the sap of Sterculia trees. Other natural gums include guar gum (E412) from guar beans, locust bean gum (E410) from the seeds of the carob tree, beta-glucan, from oat or barley bran, chicle gum obtained from the chicle tree, dammar gum from the sap of Dipterocarpaceae trees, glucomannan (E425) from the konjac plant, mastic gum, a chewing gum obtained from the mastic tree. In certain embodiments, the mucilage material includes Psyllium seed husks from the Plantago plant, spruce gum from spruce trees, tara gum (E417) from the seeds of the tare tree, and/or natural gums produced by bacterial fermentation, e.g., polyelectrolytes: gellan gum (E418) and xanthan gum (E415). Fibers of animal origin, such as keratins (e.g., silk, etc.), elastin and/or collagen may also be employed. These natural gums or fibers may be obtained from commercial sources. Insoluble and soluble fiber(s) provide a skeleton for fulfilling the gastrointestinal tract. Their amount to be added into the new jelly foods should be within a safe and effective range, such as 0.1 to 5%.

In some embodiments, the premix of dietary fibers and nutrients comprises hemicellulose or xylan, alone or compounded chemically and mechanically. These short chain polysaccharides (hemicellulose) are inexpensive and have a great capacity to absorb water or fluids. For example, the premix may comprise hemicellulose-citrate-chitosan, which is both elastic and extremely absorbent. In these or other embodiments, the premix composition comprises, or further comprises one or more fillers such as crystalline cellulose and/or amorphous cellulose, lignin or other stiffening compounds. Their amount to be added into the new jelly foods should be within a safe and effective range, such as 0.1 to 5%.

In order to obtain the desired gelling action, additional compounds may be included in the premix, in the presence or absence of hemicellulose-citrate-chitosan. Such compounds include various types of cellulose or other artificial and synthetic compounds, such as one or more of: bovine serum albuminate pectinate, pectine-ethyl cellulose, calcium pectinate and chitosan, naproxen pectin, de-esterified pectin, zinc-pectinate gels, amylose, chondroitin-sulfate, cyclodextrins, dextran, calcium alginates and alginates, locust bean gum, guar gum, glutaraldehydes, and epiclorihydrine. For example, in certain embodiments, guar gum is employed. These jellies can be shaped like cylindrical, and may have an oval, square, rectangular, triangular or polygonal or trapezoidal cross-section or shape. Further, various regular or irregular shapes of the jelly can be made. Their amount to be added into the new jelly foods should be within a safe and effective range, such as 0.1 to 5%.

In certain embodiments, the premix of vitamins and minerals may be included in the jelly. Depending on the stability of micronutrients, the invention may employ encapsulation, microencapsulation, or nanoencapsulation of the premix materials. Such, encapsulation techniques include: pan coating, air suspension coating, spray-drying, ionotropic gelation, coacervation, in situ polymerization.

Many functional agents can be added to the newly created new jelly foods. Antioxidant, such as pterostilbene, resveratrol, carotenoids, beta-carotene, lycopene can be included. Blood sugar lowering ingredient, such as garlic extract, sour cherries extract, omega-3 fatty acids can be included. Blood thinning ingredient, such as danshen root, ginkgo, turmeric, ginger, safflower, cinnamon, feverfew, cayenne peppers, tree ear mushrooms, can be included. The above functional agent can be added within a safe and effective oral dose-range determine by the current science and technology in the prior arts. The new jelly food can replace many related dietary supplement pills, Their amount to be added into the new jelly foods should be within a safe and effective range, such as 0.1 to 5%.

The other functional ingredients can also be included. The sleeping enhancement agent, such as tart-cherry extract standardized with melatonin, can be included. The flavoring agent, such as a natural orange or cherry flavoring agent, can be included. The natural or synthetic preservative, such as lemon juice or citric acid to keep the pH value of new jelly food, can be added. Their amount to be added into the new jelly foods should be within a safe and effective range, such as 0.1% to 5%.

The new jelly food can be made by using a combination of at least two of the food ingredients from vegetable, fruit, herb, egg, milk, meat industry-produced, or any other animal-originated component in any suitable percentage, like 0.1% to 80%, such as:

| | |
|---|---|
| 1) | Agar or any hydrocolloid, such as carrageenan |
| 2) | Alfalfa |
| 3) | All-purpose flour |
| 4) | Amaranth |
| 5) | Artichoke |
| 6) | Arugula |
| 7) | Athyrium esculentum |
| 8) | Avocado |
| 9) | Basil |
| 10) | Beef |
| 11) | Beet (greens) |
| 12) | Bell pepper |
| 13) | Bitter gourd |
| 14) | Bitter melon |
| 15) | Bok choy/Pak choy |
| 16) | Borage |
| 17) | Borage greens |
| 18) | Broccoli |
| 19) | Brussels sprouts |
| 20) | Cabbage |
| 21) | Caper |
| 22) | Carrot |
| 23) | Catsear |
| 24) | Cauliflower |
| 25) | Celery |
| 26) | Celtuce Lactuca sativa |
| 27) | Chaya |
| 28) | Chayote |
| 29) | Chicken |
| 30) | Chickweed |
| 31) | Chicory |
| 32) | Chicory |
| 33) | Chinese mallow |
| 34) | Collard greens |
| 35) | Common purslane |
| 36) | Corchorus capsularis |
| 37) | Corn |
| 38) | Corn salad |
| 39) | Courgette flowers |
| 40) | Cress |
| 41) | Cucumber |
| 42) | Dandelion |
| 43) | Daylily |
| 44) | Dietary fiber and water soluble |
| 45) | Dill |
| 46) | Egg |
| 47) | Eggplant |
| 48) | Endive |
| 49) | Fat hen |
| 50) | Fiddlehead |
| 51) | Fluted pumpkin |
| 52) | Garden rocket |
| 53) | Garland Chrysanthemum |
| 54) | Golden samphire |
| 55) | Good King Henry |
| 56) | Grape (leaves) |
| 57) | Greater plantain |
| 58) | Hollyhock |
| 59) | Ivy gourd |
| 60) | Kai-Ian |
| 61) | Kale |
| 62) | Komatsuna |
| 63) | Kuka |
| 64) | Lagos bologi |
| 65) | Lamb |
| 66) | Lamb's lettuce |
| 67) | Lamb's quarters |
| 68) | Land cress |
| 69) | Lettuce |
| 70) | Lizard's tail |
| 71) | Luffa |
| 72) | Malabar spinach |
| 73) | Mallow |
| 74) | Marsh mallow |
| 75) | Melokhia |
| 76) | Milk powder |
| 77) | Milkfluid |
| 78) | Miner's lettuce (Winter purslane) |
| 79) | Mizuna greens |
| 80) | Mustard |
| 81) | Napa cabbage |
| 82) | New Zealand Spinach |
| 83) | Oil (all kinds cooking oil) |
| 84) | Olive fruit |
| 85) | Orache |
| 86) | Pak choy |
| 87) | Paracress |
| 88) | Parsley |
| 89) | Pea (sprouts/leaves) |
| 90) | Pineapple |
| 91) | Plantain |
| 92) | Poke |
| 93) | Pork |
| 94) | Pumpkin |
| 95) | Rabbit |
| 96) | Radicchio |
| 97) | Rapini |
| 98) | Rice |
| 99) | Samphire |
| 100) | Sculpit |
| 101) | Sea beet |
| 102) | Sea kale |
| 103) | Shepherd's purse |
| 104) | Sierra Leone |
| 105) | Soko |
| 106) | Sorrel |
| 107) | Sour cabbage |
| 108) | Soybean |
| 109) | Spinach |
| 110) | Squash blossoms |
| 111) | Squash Cucurbita |
| 112) | Starch |
| 113) | Sugar |
| 114) | Summer purslane |
| 115) | Sweet pepper |
| 116) | Swiss chard |
| 117) | Tatsoi |
| 118) | Tinda |
| 119) | Tomatillo |
| 120) | Tomato |
| 121) | Turnip greens |
| 122) | Vanilla |
| 123) | Venison |
| 124) | Violets |
| 125) | Water |
| 126) | Water spinach |
| 127) | Watercress |
| 128) | West Indian gherkin |
| 129) | Wheatgrass |
| 130) | Winter melon |
| 131) | Yao choy (Yu choy) |
| 132) | Yarrow Achillea |
| 133) | Zucchini |
| 134) | Any other food ingredient |

The new gelatinized food is made with drinkable water, hydrocolloids/water soluble fibers, energy resource and premix of nutrients to provide an alternative to the regular food to gain the long-term anti-hunger capacity. After the new gelatinized food is ingested, the food stays in the gastrointestinal tract for much longer time so it has a significant fulfilling effect. It moves through the gastrointestinal tract slowly, and nutrients and water are absorbed into the blood gradually, not in a narrow-sharp peak fashion. The new gelatinized food is intended for consumption by human beings and certain domestic animals with a variety of health conditions.

A series of the new gelatinized food can be made and used by the individual with a variety of health conditions, so these individuals can nourish their organs. These cells and tissues will get the replacement for the lost body constituents as a result of physical activities, basic metabolism, aging, and a disease-drug caused extra need of nutrients.

These new gelatinized foods can be consumed in the cold temperature or warm-hot temperature depending on a personal eating habit. Many of these gelatinized foods are reversable from gel to thick liquid as temperature changes. This gives the user a choice of what type of texture of foods for consumption for weight control.

The healthy food is particular important for pregnant women. During the first trimester of pregnancy, many women experience the bouts of nausea and vomiting known as morning sickness. Despite its name, morning sickness can occur at any time, day or night. It usually begins around the 6th week of pregnancy, peaks around week 9, and disappears by weeks 16 to 18. Although very unpleasant, morning sickness was considered a normal part of pregnancy. But what's not normal is when morning sickness becomes so severe that a woman persistently vomits several times a day, loses weight, and becomes dehydrated to lead to dehydration. When this rare pregnancy-related condition is left untreated, it can interfere with a woman's health and her baby's ability to thrive. Use the newly disclosed new jelly food, the woman can maintain the healthy hydration which is critical to the pregnant woman and her baby.

The newly disclosed new gelatinized food can be used by anyone with overweight or obesity. There have been a lot of assumptions that both reduced physical activity and increased energy intake have been major drivers of the obesity epidemic. However, more accurate study demonstrated that the weight gain in the American population seems to be virtually all explained by eating more calories. It appears that changes in physical activity played a minimal role. Obesity is one of the biggest health risks we face. It increases the risk of many chronic disorders, notably heart and liver disease, hypertension, type 2 diabetes, some types of cancer, gallstones, sleep apnea, osteoarthritis, reflux disease, and respiratory problems—and it can seriously undermine quality of life. The adverse health effects of obesity have blunted some of the gains in longevity resulting from medical advances and declining smoking rates. It's estimated that obesity is associated with anywhere from 10 to 25 percent of all deaths and shortens life expectancy by four to seven years. Obesity rates in the U.S. have been rising for a century and have more than doubled in just the past 35 years, affecting every ethnic, demographic, and age group. More than one-third of American adults (80 million) are now obese—that is, very overweight—and another third are slightly or moderately overweight, according to government statistics. Even worse, the rate of severe obesity (usually more than 100 pounds overweight) has more than tripled during this period. What's more, 17 percent of young Americans (ages 2 to 19) are now obese, and as many are overweight. These statistics are based on the body mass index (BMI), a formula that relates weight to height. Obesity rates have also been climbing in Canada and other countries. In light of these trends, in 2013 the American Medical. Association started clas-sifying obesity as a disease, a decision that still generates debate. At the same time, the American Heart Association, the Ameri-can College of Cardiology, and the Obesity Society announced in joint guidelines that obesity should be treated as a chronic disease. To meet the need of eating to a full fullness at any meal without over intake of calorie was a big challenge in the past. Now the newly disclosed new jelly food can be used by those who are overweight and obese. Replacing 5% up to 50% of calorie for a short term for the obese people with the added nutrients by using the new jelly food can be achieved easily and safely, then weight loss becomes very easy. Gradually reduce his/her daily calorie intake by using the newly disclosed new jelly food will result in a gradual weight loss, a healthy way to become lean.

The newly disclosed new gelatinized food can be used by anyone with hangover dehydration after alcohol beverage consumption. It is commonly known that a throbbing headache, exhaustion, queasiness and even muscle fatigue can occur after a night of drinking alcohol. The cause is a combination of factors, but primarily is dehydration. Alcohol is a diuretic therefore it causes to lose water. And the dehydration effect is probably the most severe contributor to hangover. The more you drink and the higher the concentration of alcohol in the drinks you choose, the more dehydrated you are going to be. Alcohol suppresses the release of the hormone vasopressin, which normally repurposes water released by the kidneys back into the body. With the absence of vasopressin, that water is marked for the bladder and eliminated. Alcohol also causes inflammation of the stomach lining, which can cause diarrhea—another dehydrating condition. In the morning after the alcohol consumption in the night, one can have the classic dehydration symptoms: a headache as the body borrows water from the brain, causing temporary tissue shrinkage; thirst; dry mouth; nausea; and even dizziness. Another cause is duo to a unique physiological response to alcohol in terms of how it's broken down and eliminated by the body. The way different people metabolize alcohol can certainly have an effect on the onset, severity and duration of a hangover, as alcohol is metabolized in two stages: one group of enzymes break down ethanol—the alcohol that you ingest—into acetaldehyde. Acetaldehyde is a toxic, carcinogenic substance, but soon after a second class of enzymes metabolizes the acetaldehyde into harmless acetate, which is basically vinegar. The problem is that for some people, the second metabolic process can be slower and less effective than in others. That means a build-up of acetaldehyde toxicity, which includes several hangover-like symptoms like rapid pulse, sweating, skin flushing, nausea and vomiting. The newly disclosed water-binding formulation can help people to overcome the symptoms of hangover. The rehydration with the disclosed new jelly food is beneficial to all ethnic populations, although there are some ethnic patterns to this variation of hangover. Asians, Asian-Americans and Native Americans have a higher instance of a gene that causes inactivity of the enzyme aldehyde dehydrogenase-2 which, along with glutathione, metabolizes acetaldehyde into acetate. Another contributor to hangovers has to do with the taste of alcohol: congeners. These are byproducts of the distillation and fermentation process that are both good and bad—while they give alcohol, especially amber alcohols like whiskey and rum, their distinct, full flavor, they're also associated with feeling ill the next day. In any case, the prevent invention can be used for a quick recovery of hangover. Given that dehydration is accompanied by electrolyte imbalance from the loss of sodium and potassium, which might help explain those salty cravings at breakfast, rebalancing with the current invention is a good idea. Supporting this use is from the fact that Pedialyte has become a popular drink for people suffering from hangovers, with one third of its sales coming from adults. There has been a 57% increase in its use by adults since 2012. As a result, Pedialyte has begun a marketing campaign promoting the use of Pedialyte by hangover adults. The currently invented new jelly food should be a more suitable product for relieving symptoms of hangover.

The newly disclosed new gelatinized food can be used by these who have incontinence. Stress incontinence causes urine to leak when you laugh or cough. Overactive bladder (OAB), or urge incontinence, is caused by urinary muscle spasms. Multiple pregnancies, being overweight, and genetic weaknesses can increase your risk. The prevent invention is the right new jelly food for these patients to have the right hydration but not with a high frequently of urination.

The newly disclosed new gelatinized food can be used by these who have heart failure. These patients need to limit their fluid intake, so they need to prevent dehydration. Using the current invention, the patient can gradually achieve and maintain normal hydration without a rapid load of the diluted blood, which is a sudden stress for the weak-heart.

The newly disclosed new gelatinized food can be used by anyone after being burned or skin damage. Burns can cause many damages, and low blood volume is one of them. Burns can damage blood vessels and cause fluid loss. This may result in low blood volume (hypovolemia). Severe blood and fluid loss prevents the heart from pumping enough blood to the body. Rehydration via intravenous fluid is needed, but chronic hydration can be achieved by using the newly disclosed new jelly food. Gradual hydration without frequently going to bathroom due to urination is beneficial to many patients with severe burning.

The newly disclosed new gelatinized food can be used by anyone with mouth dryness after receiving radiotherapy or chemotherapy. Cancer treatment, including certain types of chemotherapy, radiotherapy, and surgery, can cause a common side effect—fever. People receiving cancer treatment are often at, risk for developing infections that can cause fever. A high fever can cause dehydration. Many cancer treatments also cause vomiting and diarrhea, which lead to dehydration. Rehydration or maintaining hydration for these cancer patients during the long-term chemotherapy can be achieved by using the newly disclosed new jelly food.

The newly disclosed new gelatinized food can be used during menstruation. The weakness during menstruation is usually caused by dehydration, due to the loss of fluid, electrolytes, and blood that occur during the period. This can be compensated by using the newly disclosed new gelatinized food. Maintaining a normal hydration during the period has a short and long-term health benefit.

The newly disclosed new gelatinized food can be used by anyone with low blood pressure due to dehydration. Low blood pressure can be caused by many conditions. During the first 24 weeks of pregnancy, it's common for blood pressure to drop. A decrease in blood volume can also cause blood pressure to drop. A significant loss of blood from major trauma, dehydration or severe internal bleeding reduces blood volume, leading to a severe drop in blood pressure. A number of drugs can cause low blood pressure, including diuretics and other drugs that treat hypertension; heart medications such as beta blockers; drugs for Parkinson's disease; tricyclic antidepressants; erectile dysfunction drugs, particularly in combination with nitroglycerine; narcotics and alcohol. Other prescription and over-the-counter drugs may cause low blood pressure when taken in combination with high blood pressure medications. Among the heart conditions that can lead to low blood pressure are an abnormally low heart rate (bradycardia), problems with heart valves, heart attack and heart failure. Your heart may not be able to circulate enough blood to meet your body's needs. Complications with hormone-producing glands in the body's endocrine systems, specifically, an underactive thyroid (hypothyroidism), parathyroid disease, adrenal insufficiency (Addison's disease), can cause low blood pressure. Septic shock can occur when bacteria leave the original site of an infection (most often in the lungs, abdomen or urinary tract) and enter the bloodstream. The bacteria then produce toxins that affect blood vessels, leading to a profound and life-threatening decline in blood pressure. Anaphylactic shock is a sometimes-fatal allergic reaction that can occur in people who are highly sensitive to drugs such as penicillin, to certain foods such as peanuts or to bee or wasp stings. This type of shock is characterized by breathing problems, hives, itching, a swollen throat and a sudden, dramatic fall in blood pressure. Unlike orthostatic hypotension, this disorder causes blood pressure to drop after standing for long periods, leading to symptoms such as dizziness, nausea and fainting. This condition primarily affects young people and occurs because of miscommunication between the heart and the brain. A lack of the essential vitamins B-12 and folic acid can cause anemia, which in turn can lead to low blood pressure. The newly disclosed new jelly food can be used by the patients with above conditions to increase blood volume, then hence leads to increase blood pressure.

The newly disclosed new gelatinized food can be used by anyone with temporary erectile dysfunction (ED) due to dehydration. In order for a man to get an erection and eventually reach orgasm, a lot of the body's systems have to work together properly. Everything from the nerves around the penis to the blood pumping by the heart flowing through the body is necessary for an erection. If one area of the body isn't working properly, erectile dysfunction can occur. Hydration is an important component for overall health, including sexual health. Without proper hydration, the body experiences complications. Several of these can lead to ED. First, the more hydrated the body is, the higher the volume of blood cells and plasma, and the more efficiently blood can flow through the veins and arteries. A low volume of red blood cells and plasma can lead to ED because the penis cannot get enough oxygen- and nutrient-rich blood to maintain an erection. Second, when fluid levels in the body fall, the body starts creating a hormone called angiotensin. This hormone causes blood vessels to constrict or tighten. This can lead to an increase in blood pressure, and it prevents adequate blood flow through the body, including the penis. Third, the increased blood pressure can reduce sexual satisfaction. As high blood pressure continues, it can damage the blood vessels and arteries. It will make them harder and narrower, which reduces blood flow permanently. Reduced blood flow can also reduce sensation in the penis and ultimately lower sexual desire. Normal hydration is also important for any women to have an easy and enjoyable sexual activity. Proper hydration by using the newly disclosed new jelly food can promote and maintain normal sexual activities.

The newly disclosed new gelatinized food can be used by anyone with diabetes. In most people with Type 1 or Type 2 diabetes, the thirst builds slowly enough that it is often incredibly difficult to notice until other symptoms present themselves or until the point of major dehydration. Excessive thirst, when linked to another condition as a symptom or comorbidity, is called polydipsia. It's usually one of the earnest symptoms of diabetes, and it is often accompanied by excessive dryness of the mouth (“cotton mouth”). When glucose becomes hyper-concentrated in the bloodstream, usually about 200 mg/dL—though this number varies from person to person, the kidney loses the ability to reuptake glucose from water. Under normal circumstances, almost all glucose is pulled out of urine and back into the body. Since the body can no longer pull glucose out from water in the kidneys, the osmotic pressure builds up. Eventually, it gets so high that water can no longer be absorbed back into the bloodstream. In fact, water is being absorbed out of the bloodstream, which cause significant thirsty. Increased thirst must be treated timely. Immediate effects of not treating severe diabetes-related dehydration can include headaches, nausea, dizziness, and fainting. For people with diabetes, dehydration can also cause diabetic ketoacidosis. Ketoacidosis is a condition that causes naturally-occurring acids to build up in the body and can lead to coma, organ failure, or even death. The newly disclosed new jelly food can be used to rehydrate the patients with diabetes. Since losing weight is commonly needed for improving the overall condition of the type 2 diabetic patients, this anti-thirsty and anti-hunger water is more suitable than the regular water or oral rehydration solution.

Severe dehydration actually causes blood sugar levels to rise faster than normal. Part of the reason for this is that the kidneys slowly begin to produce less urine than usual in the presence of prolonged dehydration, and so unable to expel as much excess glucose. A less well-known reason is that dehydration causes the body to release adrenaline and other hormones that act as insulin blockers. For those with Type 2 diabetes, the effect is as if their diabetes had suddenly kicked into overdrive, and glucose stops being broken down almost completely. Therefore, the new jelly food is very much needed to rehydrate the diabetic patients.

The newly disclosed new gelatinized food can be used by anyone with night eating syndrome. Night eating syndrome is not the same as binge eating disorder, although individuals with night eating syndrome are often binge eaters. It differs from binge eating, in that the amount of food consumed in the evening/night is not necessarily objectively large nor is a loss of control over food intake required. Individuals with night eating syndrome feel like they have no control over their eating patterns, and often feel shame and guilt over their condition. Night eating syndrome affects an estimated 1.5% of the general population, and about 10% of the college students. It is equally common in men and women, according to the National Institute of Mental Health. To meet the need of eating for the habit, the newly disclosed new jelly food is an ideal product as there is no calorie but can let the individual to feel full.

Individuals with night eating syndrome are often obese or overweight, which makes them susceptible to health problems caused by being overweight, including high blood pressure, diabetes and high cholesterol. Those who are obese increase their risk of heart diseases, many types of cancer and gallbladder disease. Individuals with night eating syndrome often have a history of substance abuse, and may also suffer from depression. They typically report being more depressed at night. They also frequently have sleep disorders. They may hide food out of shame or embarrassment. Those with night eating syndrome typically eat rapidly, eat more than most people would in a similar time period and feel a loss of control over their eating. They eat even when they are not hungry and continue eating even when they are uncomfortably full. Feeling embarrassed by the amount they eat, they typically eat alone to minimize their embarrassment. They often feel guilt, depression, disgust, distress or a combination of these symptoms. Those with night-eating syndrome eat a majority of their food during the evening. They eat little or nothing in the morning, and wake up during the night and typically fill up on high-calorie snacks. Sometimes college students pick up the habit of eating at night and are unable to break the habit when they become working adults. High achievers sometimes work through lunches, and then overcompensate by eating more at night. Night eating syndrome, ironically, may be a response to dieting. When people restrict their intake of calories during the day, the body signals the brain that it needs food and the individual typically overcompensates at night. Night eating may also be a response to stress. Those with night eating syndrome are often high achievers. However, eating patterns can affect their ability to socialize or manage work-related responsibilities. They may also have different hormonal patterns, resulting in their hunger being inverted so that they eat when they should not and do not eat when they should. To meet the need of eating and for weight control, the newly disclosed new jelly food is an ideal product as the product has no calorie and can let the individual to eat and to feel full at any time.

Successful treatment of night eating syndrome typically requires a combination of therapies. Treatment typically begins with educating patients about their condition, so they are more aware of their eating patterns and can begin to identify triggers that influence how they eat. Just identifying that they have night eating syndrome and that it is not their fault can be an important first step toward recovery. Treatment of night eating syndrome also includes nutrition assessment and therapy, exercise physiology, and an integration of cognitive-behavioral therapy (CBT), dialectical behavioral therapy (DBT), interpersonal therapy (IT) and stress management. An additional online component may also help patients gain control over their disorders. It is important for individuals with night eating syndrome to change their behavior by changing their beliefs. If they believe that they are powerless to change the way they eat, they will not be able to change. The current invention provides a new treatment, as the newly disclosed jelly food is an ideal product as the product has no calorie and can let the individual to eat as often as he/she likes and feel a long-term full without calorie.

The newly disclosed new gelatinized food can be used by anyone with binge eating disorder (BED). BED is a severe, life-threatening, and treatable eating disorder characterized by recurrent episodes of eating large quantities of food and often eat very quickly and to the point of discomfort. He or she has a feeling of a loss of control during the binge; experiencing shame, distress or guilt afterwards; and not regularly using unhealthy compensatory measures (e.g., purging) to counter the binge eating. It is the most common eating disorder in the United States. The health risks of BED are most commonly those associated with clinical obesity, weight stigma, and weight cycling (aka, yo-yo dieting). Most people who are labeled clinically obese do not have binge eating disorder. However, of individuals with BED, up to two-thirds are labelled clinically obese; people who struggle with binge eating disorder tend to be of normal or higher-than-average weight, though BED can be diagnosed at any weight. Treating BED generally involves a combination of psychological and nutritional counseling, along with medical and psychiatric monitoring. Treatment must address the eating disorder symptoms and medical consequences, as well as psychological, biological, interpersonal, and cultural forces that contribute to or maintain the eating disorder. Nutritional counseling is also necessary and should incorporate education about nutritional needs, as well as planning for and monitoring rational choices by the individual patient. There are a variety of treatments that have been shown to be effective in treating eating disorders. Generally, treatment is more effective before the disorder becomes chronic, but even people with long-standing eating disorders can and do recover. The current invention provides a new treatment, as the newly disclosed new jelly food is an ideal product as the product has no calorie and can let the individual to eat as often as he/she likes and has a long-term fullness without calorie.

For treating the other types of eating disorders, the newly disclosed new jelly food can be used to rehydrate the body, to balance electrolytes, and to have the fullness effect.

The newly disclosed new gelatinized food can be used by anyone with hyperlipidemia. Obesity was associated with hypertriglyceridemia, a high level of low density lipoprotein cholesterol and a low level of high density lipoprotein cholesterol. Obesity is defined as a medical condition of excess body fat has accumulated overtime, while overweight is a condition of excess body weight relatively to the height. According to the Body Mass Index (BMI), a BMI between 25 to 29.9 is considered over weight, while a BMI of over 30 is an indication of obesity. According to the statistic, 68% of American population are either overweight or obese. The combination of high serum triglyceride, small low-density lipoprotein cholesterol particles, and a reduction in high-density lipoprotein cholesterol levels has been identified as an atherogenic lipoprotein phenotype, or lipid triad. They were all risk factors for cardiovascular disease. That is, overweight and obesity were associated with hyperlipidemia in adults and children. The newly disclosed new jelly food can be used by any one with hyperlipidemia to reduce the body weight and lower hyperlipidemia.

The newly disclosed new gelatinized food can be used by anyone with water-electrolyte imbalance. The major electrolytes found within the human body include sodium, potassium, calcium, magnesium, chloride, phosphate, bicarbonate, and sulfate. Because these crucial nutrients help stimulate nerves throughout the body and balance fluid levels, an electrolyte imbalance can cause a variety of serious negative symptoms, including some that are potentially deadly. People obtain electrolytes through eating different foods and drinking certain fluids, while lose them partially through exercise, sweating, going to the bathroom and urinating. This is why a poor diet, too little or too much exercise, and being sick are some possible causes for an electrolyte imbalance. The level of an electrolyte in the blood can become too high or too low, leading to an imbalance. Electrolyte levels can change in relation to water levels in the body as well as other factors. Important electrolytes are lost in sweat during exercise, including sodium and potassium.

The newly disclosed new gelatinized food can be used by anyone with osteoporosis. Chronic dehydration is associated with osteopenia osteoporosis. Many people may say they never feel thirsty. Yes—with years of chronic dehydration the old adults lose sense of thirst. Many people grow to interpret the ‘thirst signal’ as a hunger signal and they snack instead of drinking 8 oz of water. As for the bone loss connection, dehydration is related to osteopenia osteoporosis. If you have osteopenia or osteoporosis, chronic Dehydration as one of your possible causes. After years of chronic dehydration the chemistry of your body may have eroded bone as part of its response to not enough water. The remedy is simple enough. Drink enough water or better, use the newly disclosed new jelly food to supply electrolytes for the bone. If you drink sodas and caffeinated drinks, you must drink twice as much plain water for each caffeinated drink you take to compensate its dehydration effect.

The newly disclosed new gelatinized food can be used by anyone for an overnight sleep due to thirsty and/or hungry during the night. Sleep deprivation occurs when the lack of restful sleep is severe enough to compromise basic body functions. Fatigue, increased thirst and restless or irritability, frequent urination; hunger or increased appetite, all contribute to poor sleep. The newly disclosed new jelly food can be used to rehydrate the body, to balance electrolytes, to meet the need of feeling, full, and reduce the need to go to bathroom. In addition, the special new jelly food for promoting sleep is made with tart cherry extract, which contain melatonin, a normal hormone for maintaining an overnight sleep. Melatonin can also be added independently since it is a safe ingredient via oral intake. Other natural herb extracts which can improve sleep can be included. The amount of adding tart cherry extract standardized melatonin, can be in the range of 0.5 to 10 grams for each use, with melatonin in the range of 0.5 mg to 10 mg per use.

The newly disclosed new gelatinized food can be used by anyone with a high urination frequency. A frequent need to get up and go to the bathroom to urinate at night is called nocturia. Diabetes, pregnancy and diuretic medications are also associated with nocturia. Until recently, nocturia was thought to be caused by a full bladder, but it is also a symptom of sleep apnea. Nocturia becomes more common as people age. When get older, people's bodies produce less of an anti-diuretic hormone to retain fluid. With decreased concentrations of this hormone, people produce more urine at night. Another reason for nocturia among the elderly is that the bladder tends to lose holding capacity as people age. Finally, older people are more likely to suffer from medical problems that may have an effect on the bladder. The newly disclosed new jelly food can be used to rehydrate the body, to balance electrolytes, and to reduce the need to go to bathroom at a high frequency by using the solid form of the water-binding product.

The newly disclosed new gelatinized food can be used by anyone with dehydration symptoms, like body pain, headache, constipation, lack of energy, lack of alertness, feeling thirsty and lightheaded, tiredness, having dark colored and strong-smelling urine, passing urine less often than usual, having few or no tears when a baby is crying, or having fewer wet nappies, or of skin dryness and/or facial dryness.

The newly disclosed gelatinized product is particularly useful for an individual who needs to have a long time of hydration and satiation without a timely supply, such as during training, fighting and working in the field. Hydrate before, during and after the exercise/training sessions. The individual should have 500 ml (or 16 oz.) of water-binding formulation two hours before exercise/training, so he/she will be hydrated and the body has enough time to excrete any extra before each session. If the exercise or training is not too long, he/she may not need to drink fresh water or sport drink. After that session, she/he can consume the new jelly food as much as one comfortably can.

The manufacture process of a new gelatinized food is very similar to these processes to make infant formulas, or to make Jellies and jams. Since infant formulas can be made in solid (power) form, ready-to-feed liquid or concentrated liquid, the new jelly food can be made in solid, semi-solid or thick liquid as well, or just like a jelly. Hydrocolloids are commonly used to manufacture jelly, jam, fruit butters, marmalades, chutney, fruit paste. Some of these food items can be used as a base to manufacture a new jelly food.

Manufacturing a new gelatinized food like making an infant formula in the powder form. Weighing, mixing and homogenizing the ingredients of the new jelly food without adding water. Seasalt premix, including essential electrolytes, premix of vitamins and minerals, premix of hydrocolloids, and/or the other optional solid ingredients can be mixed and homogenized by using the prior arts of dry blending. Individual package can be made in a small unit. When it is to be used, the mixed powder in the individual unit is added into the hot water, then cool off to form a solid, semi-solid or a thick liquid for use.

Manufacturing a new gelatinized food just like making a jelly. Weighing and adding these ingredients of the new gelatinized food to the drinkable water at the defined formulation one by one: Seasalt premix including essential electrolytes, premix of vitamins and minerals, premix of hydrocolloids, and/or the other optional ingredients. These ingredients in water will be homogenize, dissolved, and sterilized, packed, and gelatinized. If a terminal sterilization is needed, the package will be terminally sterilized by using these procedures taught in the prior arts of terminal sterilization.

A new gelatinized food can also be made by using the compote as, a starting point. When a compote is breakdown and the hard pieces are removed, mixed with water, then the premix of electrolytes and premix of hydrocolloids are added. These ingredients in water will be homogenize, dissolved, and sterilized, packed and gelatinized. The rest is same as above. This new gelatinized food will have the natural flavor of the original fruit.

A new gelatinized food can also be made by using the fruit butters as a starting point. When a fruit butter is further breakdown into fine pieces, mixed with water, then premix of electrolytes and premix of hydrocolloids are added. These ingredients in water will be homogenize, dissolved, and sterilized, packed, and gelatinized. Or then processed further as needed to make the new jelly food. The new jelly food will have the natural flavor of the original fruit.

A new gelatinized food can also be made by using marmalade as a starting point. A marmalade is made without adding hydrocolloids since the pectin content of citrus peels is high enough to work effectively. When a marmalade is further breakdown into fine pieces, then mixed with water, then premix of electrolytes and a small amount of the premix of hydrocolloids are added. These ingredients in water will be homogenize, dissolved, and sterilized, packed, and gelatinized. Or then processed further as needed to make the new jelly food. The new jelly food will have the natural flavor of the original fruit.

A new gelatinized food can also be made by using chutney as a starting point. A chutney is a further flavored jam can be consumed along a main dish. When a chutney is further breakdown into fine pieces, mixed with water, then premix of electrolytes and a small amount of the premix of hydrocolloids are added. These ingredients in water will be homogenize, dissolved, and sterilized, packed, and gelatinized. Or then processed further as needed to make the new jelly food. The new jelly food will have the natural flavor of the original fruit.

A new gelatinized food can also be made by using fruit paste as a starting point. A fruit paste is made with quince. The quince is sort of like an apple; cooked down in sugar, it takes on a gummy-like consistency. There's no pectin, no jelly bags, and usually no additional spices. The sweetness in the paste makes it just right for cheese pairing. When a fruit paste is further breakdown into fine pieces, then mixed in water, then premix of electrolytes and a small amount of the premix of hydrocolloids are added. These ingredients in water will be homogenize, dissolved, and sterilized, packed, and, gelatinized. Or then processed further as needed to make the new jelly food. The new jelly food will have the natural flavor of the original fruit.

A preferred embodiment of the invention will now be further described in the following example. The following examples are provided to illustrate certain aspects of the present invention and to aid those of ordinary skill in the art in practicing the invention. These samples should be understood to be illustrative of the present invention, should not be construed as limiting. On the contrary, the present disclosure embraces alternatives and equivalents thereof, as embodied, by the appended claims.

### Example 1

Making a new jelly food starting from a soup. Soups were obtained from a local food store in Milford, Del. area. Then the soup is measured as 500 grams and diluted with the same amount of fresh water (diluted for 2 times) to make 1000 ml. A mixture of glucomannan and carrageenan in the ratio of 2:1 in the total concentration of 3% was added to the diluted soup. The new liquid soup was further processed by heating the mixture to dissolve all added solids, then cool off naturally in the room temperature. One hour late, the new gelatinized food with the original soup flavor was available for consumption.

### Example 2

Making a new jelly food starting from SlimFast. A 6-can packages of SlimFast Original were purchased from a local Walmart store in Milford, Del. The 500 ml liquid nutrition was measured and added the same amount of water (1:1 dilution) to 1000 mL A mixture of glucomannan and carrageenan in the ratio of 2:1 in the total concentration of 3% was added to the diluted SlimFast. 12 g sodium citrate and 1.7 g citric acid were added to make the total solution at pH 5.0. The new liquid food was processed by heating the mixture to dissolve all added solids, then cool off naturally in the room temperature. One hour late, the new gelatinized food with the original SlimFast flavor was available for consumption.

### Example 3

Making a new jelly food starting from Ensure® Original. A 12-can packages of Ensure® Original were purchased from a local Walmart store in Milford, Del. The 500 ml liquid nutrition was measured and added the same amount of water (1:1 dilution) to 1000 mi. A mixture of glucomannan and carrageenan in the ratio of 2:1 in the total concentration of 3% was added to the diluted Ensure®. A 12 g sodium citrate and 1.7 g citric acid were added to make the total solution at pH 5.0. The new liquid food was processed by heating the mixture to dissolve all added solids, then cool off naturally in the room temperature. One hour late, the new gelatinized food with the original Ensure flavor was available for consumption.

### Example 4

Making a new jelly food starting from orange juice. Four bottles of orange juice were purchased from a local food store in Milford, Del. The 500 ml orange juice was measured and added the same amount of water (1:1 dilution) to 1000 ml. A mixture of glucomannan and carrageenan in the ratio of 2:1 in the total concentration of 3% was added to the diluted orange juice. The new liquid was processed by heating the mixture to dissolve all added solids, then cool off naturally in the room temperature. One hour late, the new gelatinized food with the original orange juice flavor was available for consumption.

### Example 5

Making a new jelly food starting from apple juice. Two large bottles of apple juice were purchased from a local food store in Milford, Del. The 500 ml apple juice was measured and added the same amount of water (1:1 dilution) to 1000 mL A mixture of glucomannan and carrageenan in the ratio of 2:1 in the total concentration of 3% was added to the diluted apple juice. The new liquid was processed by heating the mixture to dissolve all added solids, then cool off naturally in the room temperature. One hour late, the new gelatinized food with the original apple juice flavor was available for consumption.

### Example 6

Making a new jelly food starting from grape juice. Two large bottles of grape juice were purchased from a local food store in Milford, Del. The 500 ml grape juice was measured and added the same amount of water (1:1 dilution) to 1000 ml. A mixture of glucomannan and carrageenan in the ratio of 2:1 in the total concentration of 3% was added to the diluted grape juice. The new liquid was processed by heating the mixture to dissolve all added solids, then cool off naturally in the room temperature. One hour late, the new gelatinized food with the original grape juice flavor was available for consumption.

### Example 7

Making a new jelly food starting from mango juice. Two large bottles of mango juice were purchased from a local food store in Milford, Del. The 500 ml mango juice was measured and added the same amount of water (1:1 dilution) to 1000 mL A mixture of glucomannan and carrageenan in the ratio of 2:1 in the total concentration of 3% was added to the diluted mango juice. The new liquid was processed by heating the mixture to dissolve all added solids, then cool off naturally in the room temperature. One hour late, the new gelatinized food with the original mango juice flavor was available for consumption.

### Example 8

Making a new jelly food starting from fresh grape. Two bags of fresh grape were purchased from a local food store in Milford, Del. The seedless grape was measured for 500 grams and added the same amount of water (1:1 dilution) to 1000 ml. The mix was broken down into fine pieces with a vegetable blender. A mixture of glucomannan and carrageenan in the ratio of 2:1 in the total concentration of 3% was added to the blended grape juice. The total liquid was processed by heating the mixture to dissolve all added solids, then cool off naturally in the room temperature. One hour late, the new gelatinized food with the original grape flavor was available for consumption.

### Example 9

Making a new jelly food starting from fresh celery. Two bags of fresh celery were purchased from a local food store in Milford, Del. The vegetable was measured for 500 grams and added the same amount of water (1:1 dilution) to 1000 ml. The mix was broken down into fine pieces with a vegetable blender. A mixture of glucomannan and carrageenan in the ratio of 2:1 in the total concentration of 3% was added to the blended celery juice. The total liquid was processed by heating the mixture to dissolve all added solids, then cool off naturally in the room temperature. One hour late, the new gelatinized food with the original celery flavor was available for consumption.

### Example 10

Making a new jelly food starting from a commercial soup. Six cans of Campbell's Condensed Soup were purchased from a local food store in Milford, Del. area. Then the soup is measured as 500 grams and diluted with the same amount of fresh water (diluted for 2 times) to make 1000 mL A mixture of glucomannan and carrageenan in the ratio of 2:1 in the total concentration of 3% was added to the diluted Campbell's soup. The new liquid soup was further processed by heating the mixture to dissolve all added solids, then cool off naturally in the room temperature. One hour late, the new gelatinized food with the original soup flavor was available for consumption.

### Example 11

Making 35 g premix of hydrocolloids and nutrients. The 35 grams of premix contains glucomannan 20 grams, kappa carrageenan 5 grams, and the nutrients mixture of 10 grams. This premix can be used to make a gelatinized food after being added to 1000 ml of the 2× diluted fruit juice. The final content of the three ingredients will be 2% glucomannan, 0.5% kappa carrageenan, 1% nutrients mixture, which add 50% of the DRI shown in above Table 2 to the original food.

### Example 12

Making 25 kg premix of hydrocolloids and nutrients. The 25 kilograms of premix contains glucomannan 10 kg, kappa carrageenan 5 kg, and the nutrients mixture of 10 kg. This premix can be used to make a gelatinized food after being added to 1000 liters of the 2× diluted fruit juice. The final content of the three ingredients will be 1% glucomannan, 0.5% kappa carrageenan, 1% nutrients mixture, which contains 50% of the DRI shown in above Table 2 in addition to what were in the original fruit juice.

### Example 13

Making 20 g premix of hydrocolloids and nutrients. The 20 grams of premix contains glucomannan 10 g, kappa carrageenan 5 g, and the nutrients mixture of 5 g. This premix can be used to make a gelatinized food after being added to 1 liter of the 2× diluted liquid nutrition (SlimFast® Original). The final content of the three ingredients will be 1% glucomannan, 0.5% kappa carrageenan, 0.5% nutrient mixture, which provides additional 25% of the DRI of these nutrients shown in above Table 2, in addition to what were in the original liquid nutrition shown in its label.

### Example 14

Making 10 g premix of hydrocolloids and nutrients. The 10 grams of premix contains glucomannan 5 g, xanthan 5 g, and the nutrients mixture of 5 g. This premix can be used to make a gelatinized food after being added to 1 liter of the 2× diluted liquid nutrition (SlimFast® Original). The final content of the three ingredients will be 0.5% glucomannan, 0.5%® xanthan, 0.5% nutrient mixture, which provides additional 25%® of the DRI of these nutrients shown in above Table 2, in addition to what were in the original liquid shown in its label.

### Example 15

Making 25 g premix of hydrocolloids and nutrients. The 25 grams of premix contains glucomannan 15 g, agar 5 g, and the nutrients mixture of 5 g. This premix can be used to make a gelatinized food after being added to 1 liter of the 2× diluted liquid nutrition (SlimFast® Original). The final content of the three ingredients will be 1.5% glucomannan, 0.5% agar, 0.5% nutrient mixture, which provides additional 25% of the DRI of these nutrients shown in above Table 2, in addition to what were in the original liquid shown in its label.

### Example 16

Making 25 g premix of hydrocolloids and nutrients. The 25 grams of premix contains glucomannan 15 g, agar 5 g, and the nutrients mixture of 5 g. This premix can be used to make a gelatinized food after being added to 1 liter of the 2× diluted soup (Campbell's Soup—Vegetable). The final content of the three ingredients will be 1.5% glucomannan, 0.5% agar, 0.5% nutrient mixture, which provides additional 25% of the DRI of these nutrients in above Table 2, in addition to what were in the original soup shown in its label.

### Example 17

Making 35 g premix of hydrocolloids and nutrients. The 35 grams of premix contains glucomannan 20 grams, agar 5 grams, and the nutrients mixture of 10 grams. This premix can be used to make a gelatinized food after being added to 1000 ml of the 2× diluted vegetable juice. The final content of the three ingredients will be 2% glucomannan, 0.5% agar, 1% nutrients mixture, which add 50% of the DRI shown in above Table 2 to the original vegetable juice.

### Example 18

Making a new gelatinized food using a fresh fruit. Weighing 500 g editable part of apple and add to a vegetable blender, then adding water 465 g. Run the blender to break apple to fine pieces. Then add 35 g premix made in Example 17. Homogenize the mixture and then transferred to a cook pan to warm up to 100° C. Then cool off for 30 minutes. The new gelatinized food with apple is ready for consumption, which provided two-times of the volume of the original apple and in the gel form to have an increased effect of satiation and satiety.

### Example 19

Use the newly made gelatinized food in Example 18 to prevent the need to go to bathroom during the sleeping hours. The new gelatinized food of Example 18 was made and used by a senior woman. This woman would get up after the midnight to go to bathroom for more than two times before 6 am. After used this new gelatinized food 500 ml at 9:30 pm, she only got up one time the first night and slept much better than before. She continued to use the new gelatinized food 500 ml the next night, she had no need to get up any time during the entire night for the next nights, and she slept much better. Since then, she learned how to make this gelatinized food and continued to use this gelatinized food to help sleep every night.

### Example 20

Making a gelatinized food using fresh tart cherry. Weighing 500 g editable part of tart cherry and add to a vegetable blender, then adding water 465 g. Run the blender to break tart cherry to fine pieces. Then add 35 g premix made in Example 17 and 10 mg of melatonin. Homogenize the mixture and then transferred to a cook pan to warm up to 100° C. Then cool off for 30 minutes. The new gelatinized food with tart cherry is ready for consumption, which provided two-times of the volume of the original tart cherry and in the gel form to have an increased effect of satiation and satiety.

### Example 21

Use the gelatinized food to promoting sleep. The same gelatinized food made in Example 20 was used by a middle-aged woman. This woman, in the past, could not sleep through the night. Her sleep was not deep enough. After she consumed the newly made gelatinized food by half, 500 g (or 500 ml) at 10:20 pm, she did not have any hungry feeling through the night, or even after got up at 6:30 am. She used the other half of 500 g the next night, the same good sleep was achieved.

### Example 22

Use the new gelatinized food to reduce the need to visit bathroom during the day. The same new jelly food of Example 17 was made and used by a senior woman. This woman would visit bathroom several times in the morning and then several times in the afternoon during her day time. After used this new gelatinized food 500 ml at 9:30 am, and again at 2:30 pm, she only had the need to visit bathroom for one time in the morning and one time in the afternoon. She did not have the thirsty feeling during the day either.

### Example 23

Use the gelatinized food for thirsty-quenching. The gelatinized food of Example 7 was used by a young adult man. The young man likes to play tennis. In the past, he used bottled water or Gatorade before, during and after play for thirsty-quenching. After the new gelatinized food of Example 17 was made, he consumed 500 ml of this new food 30 minutes before playing. He did not feel thirsty during the 1-hour play. He consumed another 500 ml of this new gelatinized food 30 minutes after play and he felt no thirsty and no hunger.

### Example 24

Use the new gelatinized food to reduce body weight. The gelatinized food of Example 15 was used by an adult man. The man was slightly overweight and had a body mass index of 26. After the new gelatinized food of Example 15 was made, he consumed 500 ml of this new food in the morning before breakfast, 30 minutes before lunch and 30 minutes before dinner, every day for three days. His body weight was reduced by 1.2 pounds after day 1, then reduced another 1.1 pound after day 2, and reduced 0.9 pound after day 3. His overall food intake was reduced significantly as he did not have the hunger after consumed the 500 ml of the new jelly food three times. He did not have the thirsty feeling either.

### Example 25

Use the new gelatinized food for fullness. The new gelatinized food of Example 15 was used by an adult woman. The woman had a habit to eat due to the hungry feeling after the midnight and that habit negatively impacted her sleeping quality. After the new gelatinized food of Example 15 was made, she consumed 500 ml of this new food 30 minutes before she went to bed, each night for 14 nights. For the first night, she did not have the hungry feeling, and so she did not get up to eat. Since then, she did not get up each night for the other 2 weeks.

### Example 26

Use the new gelatinized food for easing morning sickness. The same new jelly food of Example 15 was used by a middle-aged pregnant woman. The woman had nausea and vomiting during the last week. She had a hard time to eat the other solid foods. After she used the new food of Example 15 in a small amount at any time during the day and night, she consumed a total of 1500 ml of this new food daily for two weeks. Since then, she felt much better overall and regained her energy level back quickly.

It is understood that numerous workable combinations of features and elements of the new gelatinized food foods can be manufactured according to the present invention. Practical implementations of the invention are numerous and are not limited to the detailed embodiments and descriptions provided here, which are for the purpose of clarity and to enable the making of numerous new gelatinized foods with low calorie density but high in nutrients and high in volume, and other related products by practitioners skilled in the art, according to the invention.

### REFERENCES CITED

U.S. Patent Documents

| | | |
|---|---|---|
| 3,485,235 | December 1969 | Felson |
| 3,797,492 | March 1974 | Place |
| 3,844,285 | October 1974 | Laby |
| 4,207,890 | June 1980 | Mamajek et al |
| 4,268,497 | May 1981 | Griffin et al. |
| 4,308,250 | December 1981 | Griffin et al. |
| 4,416,267 | November 1983 | Garren et al. |
| 4,432,968 | February 1984 | Page et al. |
| 4,434,153 | February 1984 | Urquhart et al. |
| 4,592,339 | June 1986 | Kuzmak et al. |
| 4,763,653 | August 1988 | Rockey |
| 4,767,627 | August 1988 | Caldwell et al. |
| 4,812,315 | March 1989 | Tarabishi |
| 5,306,300 | April 1994 | Berry |
| 5,326,564 | July 1994 | LaRosa et al. |
| 5,345,949 | September 1994 | Shalin |
| 5,971,942 | October 1999 | Gu et al. |
| 6,120,803 | September 2000 | Wong et al. |
| 6,488,962 | December 2002 | Berner et al. |
| 6,543,456 | April 2003 | Freeman |
| 6,558,400 | May 2003 | Deem et al. |
| 6,627,206 | September 2003 | Lloyd |
| 6,635,281 | October 2003 | Wong et al. |
| 6,677,318 | January 2004 | Beisel |
| 6,685,962 | February 2004 | Friedman et al. |
| 6,776,999 | August 2004 | Krumme |
| 6,981,980 | January 2006 | Sampson et al. |
| 7,449,001 | November 2008 | Stolz |
| 7,611,480 | November 2009 | Levy |
| 8,722,066 | May 2014 | Costa |
| 2003/0072804 | April 2003 | Hird et al. |
| 2007/0202152 | August 2007 | Droullard et al. |
| 2007/0207186 | September 2007 | Scanlon et al. |
| 2007/0293426 | December 2007 | Demuth |
| 2008/0089933 | April 2008 | Alon |
| 2008/0241094 | October 2008 | Burnett et al. |
| 2009/0028996 | January 2009 | Yamka et al. |
| 2009/0035367 | February 2009 | Mintchev et al. |
| 2010/0196470 | August 2010 | Alon |
| 2010/0215733 | August 2010 | Alon |
| 2011/0295299 | December 2011 | Braithwaite et al. |
| 2014/0276330 | September 2014 | Costa |

Foreign Patent Documents

| | | |
|---|---|---|
| 104640604 | May 2015 | CN |
| WO 02/102243 | December 2002 | WO |
| WO 2005/074378 | August 2005 | WO |
| WO 2010/063466 | June 2010 | WO |
| WO 2010/110882 | September 2010 | WO |
| WO 2011/038949 | April 2011 | WO |
| WO 2013/148359 | October 2013 | WO |

### Other References

Alexander SP1, et al. A1 adenosine receptor inhibition of cyclic AMP formation and radioligand binding in the guinea-pig cerebral cortex. Br J Pharmacol. (1994), 113(4):1501-7.
Cooley K, Szczurko O, Mills Edward, Bernhardt B, Seely D (2009). Naturopathic Care for Anxiety. www.plosone.org.
Filippa N, et al. Mechanism of protein kinase B activation by cyclic AMP-dependent protein kinase. Mol Cell Biol. (1999), July; 19(7):4989-5000
Godard M P, Johnson B A, Richmond S R. Body composition and hormonal adaptations associated with forskolin consumption in overweight and obese men. Obes Res. (2005), 13(8):1335-43.
Gupta S K, Dua A, Vohra B P. Withania somnifera (Ashwagandha) attenuates antioxidant defense in aged spinal cord and inhibits copper induced lipid peroxidation and protein oxidative modifications. Drug Metabolism Drug Interactions. 2003; 19(3):211-22
Henderson 5, et al. Effects of coleus forskohlii supplementation on body composition and hematological profiles in mildly overweight women. J Int Soc Sports Nutr. (2005), 9; 2:54-62.
Jagtap M, Chandola H M, Ravishankar B. Clinical efficacy of Coleus forskohlii (Willd.) Brig. (Makandi) in hypertension of geriatric population. Ayu. (2011), January; 32(1):59-65.
Jayaprakasam B, Padmanabhan K, Nair M G. Withanamides in Withania somnifera fruit protect PC-12 cells from beta-amyloid responsible for Alzheimer's disease. Phytotherapy Research. 2010, 24(6):859-63
Kalani A, Bahtiyar G, Sacerdote A. Ashwagandha root in the treatment of non-classical adrenal hyperplasia. British Medical Journal Case Reports 2012, 10(1136).
Kim K J, Lee O H, Lee B Y. Fucoidan, a sulfated polysaccharide, inhibits adipogenesis through the mitogen-activated protein kinase pathway in 3T3-L1 preadipocytes. Life Sci. (2010), 22; 86(21-22):791-797.
Kim M J, Chang U J, Lee J S. Inhibitory effects of Fucoidan in 3T3-L1 adipocyte differentiation. Mar Biotechnol (NY). (2009), 11(5):557-562.
Liu J Z and Lin X Y. Calorie-Nutrients Quadrant for Expressing Nutritional Values of Foods. Journal of Shandong Medical College, 1984, Vol 22 (3): page 25-31.
Martin L F, et al. Alterations in adipocyte adenylate cyclase activity in morbidly obese and formerly morbidly obese humans. Surgery. (1990) 108(2):228-235.
Mattes R (2006) Liquid calories and energy balance: the good, the bad and the uncertain. Physiology & Behavior 89: 66-70.
Moro C O, Basile G. Obesity and medicinal plants. Fitoterapia. (2000), 71, 1:S73-82.
Panda S, Kar A. Changes in thyroid hormone concentrations after administration of ashwaganda root extract to adult male mice. J of Pharmacology 1998, 50:1065-1068.
Panda S, Kar A. Withania somnifera and Bauhinia purpurea in the regulation of circulating thyroid hormone concentrations in female mice. Journal Ethnopharmacology 1999, 67(2):233-9.
Park M K, Jung U, Roh C. Fucoidan from marine brown algae inhibits lipid accumulation. Mar Drugs. (2011), 9(8):1359-1367.
Puri, Harbans Singh. Rasayana: ayurvedic herbs for longevity and rejuvenation—Volume 2 of Traditional herbal medicines for modern times. S.I.: CRC Press, 2002. ISBN 0415284899, 9780415284899.
Rolls B J, Bell E A & Waugh B A (2000) Increasing the volume of a food by incorporating air affects satiety in men. American Journal of Clinical Nutrition 72: 361-68.
Seamon K B. Activation of hormone-sensitive adenylate cyclase by forskolin. Drug Metabolism Research 1985, Volume 6, Issue 3, Pages 181-192.

Doctor's Presentations
Dr. Barbara Rolls, Volumetrics https://www.amazon.com/Volumetrics-Weight-Control-Plan-Barbara-Rolls/dp/038082176
Dr. Oz Pure Forskolin Extract 20% Recommended for Weight Loss https://www.youtube.com/watch?v=nzUv-mW4onU
Dr. Oz's Two-Week Rapid Weight-Loss Plan. http://www.doctoroz.com/topic/drozs-two-week-rapid-weight-loss-plan
Dr. Oz The 21-Day Weight Loss Breakthrough Diet Instructions. http://www.doctoroz.com/gallery/21-day-weight-loss-breakthrough-diet-instructions
Dr. Oz 5 Weight Loss Benefits of Apple Cider Vinegar http://www.doctoroz.com/gallery/5-weight-loss-benefits-apple-cider-vinegar
Dr. Axe: Individual products for weight loss. https://draxe.com/

What is claimed is:

1. A meal cylinder, a measurement instrument used to measure person's gastrointestinal fullness level after consumed a food/meal, comprising:
(1) one dimensional tube labelled with a gradient starting from 0 to a maximum number like 100 or 500 to measure a person's gastrointestinal cylinder fullness level when the paralleled amount of food/meal was consumed;
(2) one dimensional tube labelled with a gradient starting from 0 to a maximum number like 100, up to 1000 to measure the calorie cylinder fullness level of a meal/food when the paralleled amount of food/meal was consumed;
(3) one dimensional tube labelled with a gradient starting from 0 to a maximum number like 100, up to 1000 to, measure the nutrient cylinder fullness level of a meal/food when the paralleled amount of food/meal was consumed;
(4) two-dimensional tubes respectively labelled with a gradient starting from 0 to a maximum number like 100, 500 or 1000 to measure a person's gastrointestinal cylinder fullness level and the calorie cylinder fullness level of a meal/food;
(5) two-dimensional tubes respectively labelled with a gradient starting from 0 to a maximum number like 100, 500 or 1000 to measure a person's gastrointestinal cylinder fullness level and the nutrient cylinder fullness level of a meal/food;
(6) two-dimensional tubes respectively labelled with a gradient starting from 0 to a maximum number like 100, 500 or 1000 to measure the calorie cylinder fullness level and nutrient cylinder fullness level of a meal/food.
(7) three-dimensional tubes respectively labelled with a gradient starting from 0 to a maximum number like 100, 500 or 1000 to measure a person's gastrointestinal fullness level, the calorie cylinder fullness level, and the nutrient cylinder fullness level of a meal/food when the paralleled amount of food/meal was consumed.

2. The meal cylinder of claim 1, wherein said measurement instrument can be made physically with plastic, glass, wooden, metal or other safe materials, or can be made electronically with a software, or can be made mathematically and be used by a person for recording and for calculation.

3. The meal cylinder of claim 1, wherein said measurement instrument can be used to label a meal or a food for its quality and quantity in terms of the gastrointestinal fullness level, calorie and nutrient quantity.

4. The meal cylinder of claim 1 can be used to make a person's meal plan on a per meal basis, and/or on a daily basis, for monitoring food intake for each meal at home, in restaurant, in hospital, or any other appropriate place, and for education.

5. A composition of a body weight management product which can cause the body weight to increase, decrease, or maintain the same by changing the proportion of water, hydrocolloids and other ingredients to adjust the meal cylinder fullness level, calorie cylinder fullness level and nutrient cylinder fullness level, comprising:
(I) water, which accounts for the total weight of the food from 15% to 95%;
(II) a combination of at least two food ingredients from vegetable, fruit, herb, egg, milk, meat, industry-produced, or any other animal-originated food ingredient in any suitable percentage, like 0.1% to 80%, and said food ingredient is:
Agar or any hydrocolloid, such as
carrageenan, Konjac, or xanthan
Alfalfa
All-purpose flour
Amaranth
Artichoke
Arugula
Athyrium esculentum
Avocado
Basil
Beef
Beet (greens)
Bell pepper
Bitter gourd
Bitter melon
Bok choy/Pak choy
Borage
Borage greens
Broccoli
Brussels sprouts
Cabbage
Caper
Carrot
Catsear
Cauliflower
Celery
Celtuce Lactuca sativa
Chaya
Chayote
Chicken
Chickweed
Chicory
Chicory
Chinese mallow
Collard greens
Common purslane
Corchorus capsularis
Corn
Corn salad
Courgette flowers
Cress
Cucumber
Dandelion
Daylily
Dietary fiber and water soluble
Dill
Egg
Eggplant
Endive
Fat hen
Fiddlehead
Fluted pumpkin
Garden rocket
Garland Chrysanthemum
Golden samphire
Good King Henry
Grape (leaves)
Greater plantain
Hollyhock
Ivy gourd
Kai-Ian
Kale
Komatsuna
Kuka
Lagos bologi
Lamb
Lamb's lettuce
Lamb's quarters
Land cress
Lettuce
Lizard's tail
Luffa
Malabar spinach
Mallow
Marsh mallow
Melokhia
Milk powder
Milk fluid
Miner's lettuce (Winter purslane)
Mizuna greens
Mustard
Napa cabbage
New Zealand Spinach
Oil (all kinds cooking oil)
Olive fruit
Orache
Pak choy
Paracress
Parsley
Pea (sprouts/leaves)
Pineapple
Plantain
Poke
Pork
Pumpkin
Rabbit
Radicchio
Rapini
Rice
Samphire
Sculpit
Sea beet
Sea kale
Shepherd's purse
Sierra Leone
Soko
Sorrel
Sour cabbage
Soybean
Spinach
Squash blossoms
Squash Cucurbita
Starch
Sugar
Summer purslane
Sweet pepper
Swiss chard
Tatsoi
Tinda
Tomatillo
Tomato
Turnip greens
Vanilla
Venison
Violets
Water melon
Water spinach
Watercress
West Indian gherkin
Wheatgrass
Winter melon
Yao choy (Yu choy)
Yarrow Achillea
Zucchini
Any other food ingredient
(III) Hydrocolloids, individually or in any combination, preferred with prebiotic activity, such as oligosaccharides or glucomannan, xanthan gum, carboxymethyl cellulose (CMC), methyl cellulose, hydroxypropylmethyl cellulose, gum Arabic, galactomannans, glucomannan, gum tragacanth agar, modified starch, carrageenan, low or high methoxy pectin, gellan gum, alginate, methyl and hydroxypropylmethyl cellulose, collagen, to hold water to increase the volume of the food to increase the gastrointestinal tract cylinder fullness level, and to enable the user to reach fulness for a relatively longer time of period, within a safe and effective range, such as 0.1 to 5%;
(IV) optional to have proteins, such as soy protein, dairy protein or meat proteins, within a safe and effective range such as 1% to 50%, to increase gastrointestinal tract cylinder fullness level and to meet the user's need to rebuild and repair the tissue;
(V) optional to include calorie source, such as fat or oil, carbohydrate, and/or protein, within a safe and effective range determine by the current food science and technology;
(VI) optional to have premix of vitamins and minerals, such as vitamin A, folic acid, calcium, iron, selenium, to meet the health need of a user, within a safe and effective range determine by the current nutritional science and technology;
(VII) optional to have metabolic rate impacting agent, such as iodine, ginseng extract, carnitine, green tea extract, raspberry ketone, inositol or choline, within a safe and effective range determine by the current science and technology;
(VIII) optional to add functional ingredients, such as antioxidant (resveratrol, carotenoids, beta-carotene, lycopene), blood sugar lowering ingredient (garlic extract, sour cherries extract, omega-3 fatty acids), blood thinning ingredient (danshen root, ginkgo, turmeric, ginger, safflower, cinnamon, feverfew, cayenne peppers, tree ear mushrooms) within a safe and effective range determine by the current food science and technology;
(IX) optional to add taste masking or flavor agent, such as chicken broth base & seasoning, within a safe and effective range determine by the current food science and technology;
(X) optional to include food preservative or color agent, within a safe and effective range determine by the current food science and technology.

6. The composition of claim 5, wherein said at least two food ingredients are used in addition to water and hydrocolloid and each varies from 0.05% to 95%.

7. The composition of claim 5, wherein said food ingredients can be natural or synthetic, or can be raw, fresh, preserved, cooked or semi-cooked, a whole thing in its original, or broken down into any size and shape;

8. The composition of claim 5, wherein said premix of vitamin and mineral is used from the range of 1% to 100% of its reference value of the Dietary Reference Intake (DRI) issued and updated by the Food and Nutrition Board of the Institute of Medicine, National Academy of Sciences, periodically.

9. The composition of claim 5, wherein said protein, fiber, oil, or sugar can be used from the range of 1% to 99% of its Daily Reference Value (DRV), developed by the U.S. Food and Drug Administration for the dietary intake of energy-containing macronutrients, including carbohydrates, cholesterol, fat, fiber, saturated fatty acids, potassium, protein, and sodium.

10. The composition of claim 5, wherein said ingredients, in whole or in part, can be a pre-mix in a dry powder form, or in liquid form, or in suspension form, or in a cream form.

11. A method of making an improved and gelatinized food with the increased volume and weight, the increased meal cylinder fullness level, and the increased satiation and satiety effects from the original food formulation for a mammal to have a desired body weight comprising:
1) adding 1 up to 10 times volume of water to the original food formulation, such as a soup, a juice, a soft drink, a solid or semi-solid food, or the other food;
2) adding a premix containing 1% to 90% hydrocolloids and 0.5% to 50% premix of vitamins and minerals (including electrolytes), to make a new gelatinized food with a much bigger volume, less calorie, more or same amount of nutrients as compared to the original food formulation;
3) optionally adding a metabolic enhancing agent, such as ginseng extract; optionally including a calorie resource, such as carbohydrate, fat and protein, optionally including an antioxidant, such as resveratrol; optionally including a food ingredient with blood sugar lowering activity, such as garlic extract; optionally including a food ingredient with blood thinning activity, such as safflower extract, optionally including a flavor agent; optionally including a preserve agent, such as citric acid;
4) mixing and homogenizing the mixture; and sterilizing the mixture when needed;
5) packing said gelatinized food with preset amount of the to-be-gelatinized material after being poured into overhead funnels through which said to-be-gelatinized food flows down into a food container, such as bags made of either polypropylene or multiply paper, and the food containers are then vacuumed sealed.

12. A method of making an improved and gelatinized food with the increased volume and weight, the increased meal cylinder fullness level, and the increased satiation and satiety effects from the original food formulation for a mammal to have a desired body weight of claim 11, wherein said mammal is a person with overweight or obesity, and/or with hyperlipidemia.

13. A method of making an improved and gelatinized food with the increased volume and weight, the increased meal cylinder fullness level, and the increased satiation and satiety effects from the original food formulation for a mammal to have a desired body weight of claim 11, wherein said mammal is a person with diabetes, and/or hyperglycemia.

14. A method of making an improved and gelatinized food with the increased volume and weight, the increased meal cylinder fullness level, and the increased satiation and satiety effects from the original food formulation for a mammal to have a desired body weight of claim 11, wherein said mammal is a person who has hypertension.

15. A method of making an improved and gelatinized food with the increased volume and weight, the increased meal cylinder fullness level, and the increased satiation and satiety effects from the original food formulation for a mammal to have a desired body weight of claim 11, wherein said mammal is a person who has hyperuricemia.

16. A method of making an improved and gelatinized food with the increased volume and weight, the increased meal cylinder fullness level, and the increased satiation and satiety effects from the original food formulation for a mammal to have a desired body weight of claim 11, wherein said mammal is a person who has difficulty in overnight sleep due to hungry and/or thirsty during the night.

17. A method of making an improved and gelatinized food with the increased volume and weight, the increased meal cylinder fullness level, and the increased satiation and satiety effects from the original food formulation for a mammal to have a desired body weight of claim 11, wherein said mammal is a person with night eating syndrome or binge eating disorder.

18. A method of making an improved and gelafinized food with the increased volume and weight, the increased meal cylinder fullness level, and the increased satiation and satiety effects from the original food formulation for a mammal to have a desired body weight of claim 11, wherein said mammal is a person who wants to restrict calorie intake and to have adequate nutrients for long term health.

19. A method of making an improved and gelatinized food with the increased volume and weight, the increased meal cylinder fullness level, and the increased satiation and satiety effects from the original food formulation for a mammal to have a desired body weight of claim 11, wherein said mammal is a person who wants to maintain the desired body weight and to have adequate nutrients for long term health.

20. A method of making an improved and gelatinized food with the increased volume and weight, the increased meal cylinder fullness level, and the increased satiation and satiety effects from the original food formulation for a mammal to have a desired body weight of claim 11, wherein said mammal is a person who wants to grow tall and lean healthily without hunger.
